(19) United States
(12) Patent Application Publication
(10) Pub. No.: US 2012/0113831 A1
(43) Pub. Date: May 10, 2012

(54) Determination of Carriers and Multiplexing for Uplink Control Information Transmission

(75) Inventors: Ghyslain Pelletier, Laval (CA); Paul Marinier, Brossard (CA); Shahrokh Nayeb Nazar, Sainte-Julie (CA); Marian Rudolf, Montreal (CA); Robert L. Olesen, Huntington, NY (US); Kyle Jung-Lin Pan, Smithtown, NY (US); Allan Y. Tsai, Boonton, NJ (US); Mihaela C. Beluri, Huntington, NY (US); Changsoo Koo, Melville, NY (US); Sung-Hyuk H. Shin, Northvale, NJ (US); John W. Haim, Baldwin, NY (US); Janet A. Stern-Berkowitz, Little Neck, NY (US)

(73) Assignee: INTERDIGITAL PATENT HOLDINGS, INC., Wilmington, DE (US)

(21) Appl. No.: 13/098,381

(22) Filed: Apr. 29, 2011

Related U.S. Application Data
(60) Provisional application No. 61/329,748, filed on Apr. 30, 2010.
(60) Provisional application No. 61/330,070, filed on Apr. 30, 2010.
(60) Provisional application No. 61/356,281, filed on Jun. 18, 2010.
(60) Provisional application No. 61/356,211, filed on Jun. 18, 2010.
(60) Provisional application No. 61/373,520, filed on Aug. 13, 2010.
(60) Provisional application No. 61/373,672, filed on Aug. 13, 2010.
(60) Provisional application No. 61/391,385, filed on Oct. 8, 2010.

(51) Int. Cl. H04W 24/00; H04L 12/26; H04W 72/04

(52) U.S. Cl. 370/252; 370/329

(57) ABSTRACT

Embodiments contemplate methods and devices that may select uplink (UL) transmission resources for transmitting uplink control information (UCI). A determination may be made that UCI should be transmitted. A physical channel resource for transmission of the UCI may be selected and a wireless transmit/receive unit (WRTU) may transmit the UCI over a physical uplink channel capable of supporting multiple component carriers using the selected physical channel resource. The selection of the physical channel resource may include at least one of: selecting a pre-determined UL component carrier (CC) for uplink transmission on a physical uplink control shared channel (PUSCH) upon a PUSCH resource being available in a subframe, or, selecting a pre-determined UL CC for uplink transmission on a physical uplink control channel (PUCCH) capable of UCI transmission in the subframe upon a PUSCH resource not being available in the subframe.

### CROSS REFERENCE

This application claims the benefit of U.S. Provisional Application No. 61/329,748, titled “Method and Apparatus for Component Carrier Selection for Transmission of Uplink Control Information using Multiple Carriers”, filed Apr. 30, 2010; U.S. Provisional Application No. 61/330,070, titled “Uplink Control Information (UCI) Transfer using a Physical Uplink Shared Control Channel (PUSCH)”, filed on Apr. 30, 2010; U.S. Provisional Application No. 61/356,281, titled “Method and Apparatus for Increasing Multiplexing Gain and Reducing Overhead for Uplink Control Information”, filed on Jun. 18, 2010; U.S. Provisional Application No. 61/356,211, titled “Uplink Control Information Reporting on Shared Control Channel”, filed on Jun. 18, 2010; U.S. Provisional Application No. 61/373,520, titled “Multiplexing Uplink L1/L2 Control and Data”, filed Aug. 13, 2010; U.S. Provisional Application No. 61/373,672, titled “Method and Apparatus for Component Carrier Selection for Transmission of Uplink Control Information using Multiple Carriers”, filed Aug. 13, 2010; U.S. Provisional Application No. 61/391,385, titled “UCI Reporting on PUSCH in LTE with Carrier Aggregation”, filed Oct. 8, 2010, the entire contents of each respective provisional application is hereby incorporated by reference herein for all purposes.

### BACKGROUND

In wireless communication systems, Uplink Control Information (UCI) comprises numerous control and status information indicators that facilitate transmission procedures at the physical layer. For example, a UCI could contain a Hybrid Automatic Retransmission Request (HARQ) Acknowledgement or Negative Acknowledgement (ACK/NACK) that can be used to indicate a HARQ was properly received. UCI could also include a Channel Quality Indicator (CQI) which can serve as a measurement of the communication quality of the wireless channel. The CQI for a given channel can depend on the type of modulation scheme used by the communications system.

In other examples, UCI can include a Scheduling Requests (SR) which can serve to request radio transmission resources for an upcoming downlink or uplink transmission. In yet other examples, UCI can comprise a Precoding Matrix Indicator (PMI) or Rank Indicator (RI) for downlink or uplink transmission. The PMI can be used to facilitate communication over multiple data streams and signal interpretation at the physical layer, by indicating a designated precoding matrix. An RI can indicate the number of layers that can be used for spatial multiplexing in the communication system or perhaps the maximum number of such layers. A wireless transmit/receive unit (WTRU) (or User Equipment (UE)) may transmit UCI to the network and/or a base station in order to provide the physical layer with information that facilitates wireless communication.

### SUMMARY

This Summary is provided to introduce a selection of concepts in a simplified form that are further described below the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Embodiments contemplate component carrier selection for transmission of uplink control information that may use multiple carriers. Contemplated methods include configuring a Release 10 (R10) wireless transmit/receive unit (WTRU) in multicarrier operation, selecting uplink (UL) resource for transmission of Uplink Control Information (UCI), in a subframe for which the WTRU has at least one Physical Uplink Shared Channel (PUSCH) resource allocated. The method also provides for a WTRU supporting multicarrier operation, and provides for dynamic determination of resources of UL component carriers (CC) to use for transmission of UCI.

Embodiments contemplate methods for selecting uplink (UL) transmission resources for transmitting uplink control information (UCI). The method may include determining that an UCI should be transmitted and selecting a physical channel resource for transmission of the UCI. Further, the method may include transmitting, from a wireless transmit/receive unit (WRTU), the UCI over a physical uplink channel capable of supporting multiple component carriers using the selected physical channel resource.

Embodiments contemplate that a User Equipment (UE)/Wireless Transmit Receive Device (WRTU) may support multicarrier operation, methods to dynamically determine what resource of which Uplink (UL) Component Carrier (CC) may be used for the transmission of Uplink Control Information (UCI), using at least one of the following techniques: Random Selection: where the UE may select randomly among a number of UL CCs; Priority-Based Selection: where the UE may select a UL CC based on a priority criteria; Semi-Static Selection: where the UE may use resources of a pre-determined UL CC, such as a configured UL CC or a UL PCC (Primary Component Carrier), and/or a configured UL CC or a UL PCC, either occasionally or perhaps always; Explicit Selection: where the UE may select a UL CC explicitly signaled by the network (NW); Pairing-Based Selection: where UE may select a UL CC that may not be used for transmission of UCI pertaining to different UL/DL CC pair.

Embodiments contemplate Channel Quality Based Selection: where the UE may select a UL CC as a function of one or more specific characteristics of the allocated PUSCH resource, including: The resources that may be allocated for the transmission on PUSCH, a function of the number of resource blocks (RB or RBs) that may be allocated for the PUSCH transmission (e.g. the UE may select the PUSCH with the highest number of RBs, a function of the modulation and coding scheme (MCS) that may be allocated for the PUSCH transmission (e.g. the UE may select the PUSCH with the most conservative MCS; the power headroom that may be available for the transmission on PUSCH; the transmission power that may be available for the transmission on PUSCH; and/or the pathloss of the associated DL CC.

Embodiments contemplate methods and systems for transmitting uplink control information (UCI) in multicarrier system using PUSCH. A UE may determine a number of UCI bits. The UE may transmit UCI bits in subframes by scaling the number of channel coded bits by multiplexing UCI (such as HARQ ACK/NACK or RI) and Uplink Shared Data (USD) on PUSCH, replicating UCI across codewords, distributing UCI across codewords, and mapping UCI to a single codeword.

Embodiments contemplate that a UE may modify the mapping of HARQ ACK/NACK offset values and/or RI offset values. A UE may also maintain constant energy per UCI bit. A UE may also be configured to determine a number of UCI modulation symbols to retransmit with one codeword disabled.

Embodiments contemplate methods for transmitting uplink control information (UCI) by a wireless transmit receive device (WTRU). The method may include determining that UCI is to be transmitted and identifying one or more coded symbols, the one or more coded symbols may correspond to the UCI. The method may also include transmitting the UCI from the WTRU using the coded symbols simultaneously over a physical channel with multiple component carriers (CC).

Embodiments may maximize the Euclidean distance between modulation symbols as well multiplexing coded bits into a subframe in a manner that enhances time diversity.

Embodiments contemplate methods and systems for transmitting uplink control information (UCI) in multicarrier system using Physical Uplink Shared Channel (PUSCH) channel. In the embodiments, a User Equipment (UE) may determine a number of Uplink Control Information (UCI) bits using various disclosed methods. The UE may transmit UCI bits in subframes using various methods, including scaling the number of channel coded bits by multiplexing UCI (such as HARQ ACK/NACK or RI) and Uplink Shared Data (USD) on PUSCH, replicating UCI across codewords/layers, distributing UCI across codewords/layers, and mapping UCI to a single codeword.

Embodiments contemplate that a UE may modify the mapping of HARQ ACK/NACK offset values and/or Rank Identification (RI) offset values. Embodiments also contemplate that a UE may maintain constant energy per UCI bit. A UE may also be configured to determine a number of UCI modulation symbols to retransmit with one codeword disabled. Embodiments also contemplate that the Euclidean distance between modulation symbols may be maximized and coded bits may be multiplexed into a subframe in a manner that enhances time diversity.

Embodiments contemplate methods and apparatuses for increasing multiplexing gain in wireless communications may apply a multiplexing mode to uplink (UL) control channel information (UCI), and transmit the UCI on a shared channel such as a Physical Uplink Shared Channel (PUSCH). A multiplexing method may be implemented in an apparatus for Physical Uplink Shared Channel (PUSCH) transmitting uplink control information (UCI).

Embodiments contemplate that methods and apparatuses may use PUSCH for transmitting UL control information and multiplex different WTRUs' control information within the same allocated PUSCH. The method and apparatus may also use L1/2 control for example, Physical Data Control Channel (PDCCH) or higher layer signaling, such as radio resource control (RRC) signaling or combination of them to configure and/or allocate resources for transmitting and receiving UL control transmission for multiple WTRUs that are multiplexed in the PUSCH. The methods and apparatuses may implement various multiplexing methods, for example, Code division multiplexing (CDM) based PUSCH for UCI, Frequency division multiplexing (FDM) based PUSCH for UCI, and Time division multiplexing (TDM) based PUSCH for UCI.

Embodiments contemplate methods for multiplexing wireless data. The method may include multiplexing a plurality of wireless transmit/receive unit (WTRU) data in a same resource block (RB) using different subcarriers within the same RB. Also the method may include allocating one or more resource blocks (RBs) for uplink control information (UCI) for multiple wireless transmit/receive units (WTRUs).

Embodiments contemplate that methods an apparatuses may be used for multiplexing for control channel using a PUSCH container or a PUCCH container. The methods and apparatuses may use a PUSCH for transmitting UCI and multiplex multiple WTRUs' control information within the same allocated PUSCH resource. The methods and apparatuses may use L1/2 control signaling, such as PDCCH, higher layer signaling, such as RRC signaling, or a combination of both to configure and/or allocate resources for transmitting and receiving UL control transmission for multiple WTRUs that may be multiplexed in the PUSCH. The methods and apparatuses may implement various multiplexing methods, for example, CDM based PUSCH for UCI, FDM based PUSCH for UCI, and TDM based PUSCH for UCI.

Embodiments contemplate methods and apparatuses may overlay a PUCCH structure onto the PUSCH container. The methods and apparatuses may use DFT-Spread OFDM (DFT-S-OFDM).

Embodiments contemplate that methods and apparatuses may use a fixed resource allocation (RA), such as a fixed resource block (RB) or resource block group (RBG). Alternatively, dynamic downlink control information (DCI) based RA may be used. In addition, the methods and apparatuses may include RA bits in the RRC configuration. Higher layer resource configurations may be applied. In a DCI-based RA, the method and apparatus may use an identifier. This identifier may be a code-point, a flag or bit(s) in DCI format that may distinguish between “control”-type and regular “data”-type PUSCH.

Embodiments contemplate that methods and apparatuses may be used for channel multiplexing for uplink control channel using a PUCCH container. When there is an insufficient PUCCH resource for channel multiplexing such as channel selection multiplexing, an offset may be used to reserve the PUCCH resource. The reserved PUCCH resources using offset can be used for multiplexing HARQ feedback (ACK/NACKs) for transport blocks (TB), serving cells and/or component carriers (CC), for example. This offset can be fixed or may be eNode-B-configurable. Either a fixed offset or a configurable offset (if designed so) may be applied to a PDCCH or PUCCH to reserve additional PUCCH resources for HARQ ACK/NACK feedback transmission and multiplexing for serving cells, transport blocks (TB) or component carriers to support channel selection (CS) user multiplexing. Embodiments contemplate that if there is a PDCCH, resource offset may be applied to DL assignment PDCCH CCE address. Alternatively, if there is no PDCCH, resource offset may be applied to PUCCH resource index, for example.

Embodiments contemplate that methods and apparatuses may be used where there is an insufficient resource for user multiplexing. For example, the second control channel element (CCE) of the PDCCH or DCI may be used to indicate, reserve, or assign an additional PUCCH resource, for example the third and fourth PUCCH resources.

Embodiments contemplate that methods and apparatuses may be used for user multiplexing when there may be over-sufficient PUCCH resources. In this example, the PUCCHs that are not used may be re-assigned to other WTRUs. By doing so, additional WTRUs may be multiplexed at the same time in the same PUCCH resource or RB. The WTRU's multiplexing gain may be increased by applying an offset to the PUCCH resources or resource indices. The WTRU may re-map the PUCCH resource from the PDCCH CCE address. The WTRU may also us a redundant PUCCH resource for supporting SORTD and user multiplexing when SORTD is configured for the WTRU.

These and additional aspects of the current disclosure are set forth in more detail below.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 2 is a system diagram of an example radio access network and an example core network that may be used within the communications system illustrated in FIG. 1A;

FIG. 3 is a diagram of the channels that may be used in an example LTE system consistent with embodiments;

FIG. 4 is a diagram of an example DFT-S-OFDM based PUCCH consistent with embodiments;

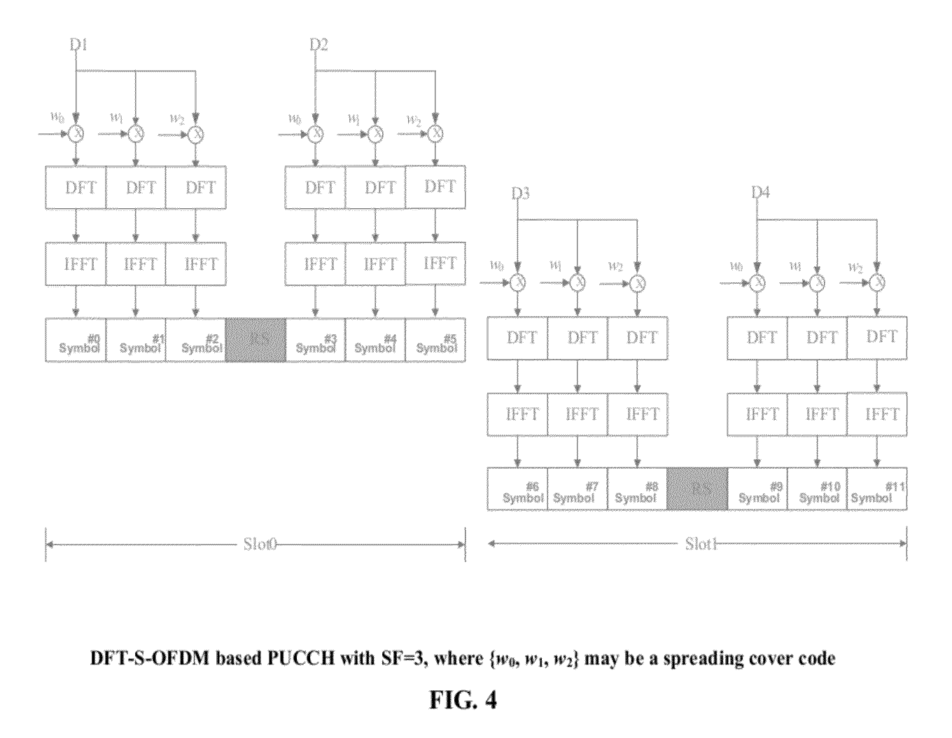

FIG. 5 is a diagram of an example PUSCH multiplexing scheme consistent with embodiments;

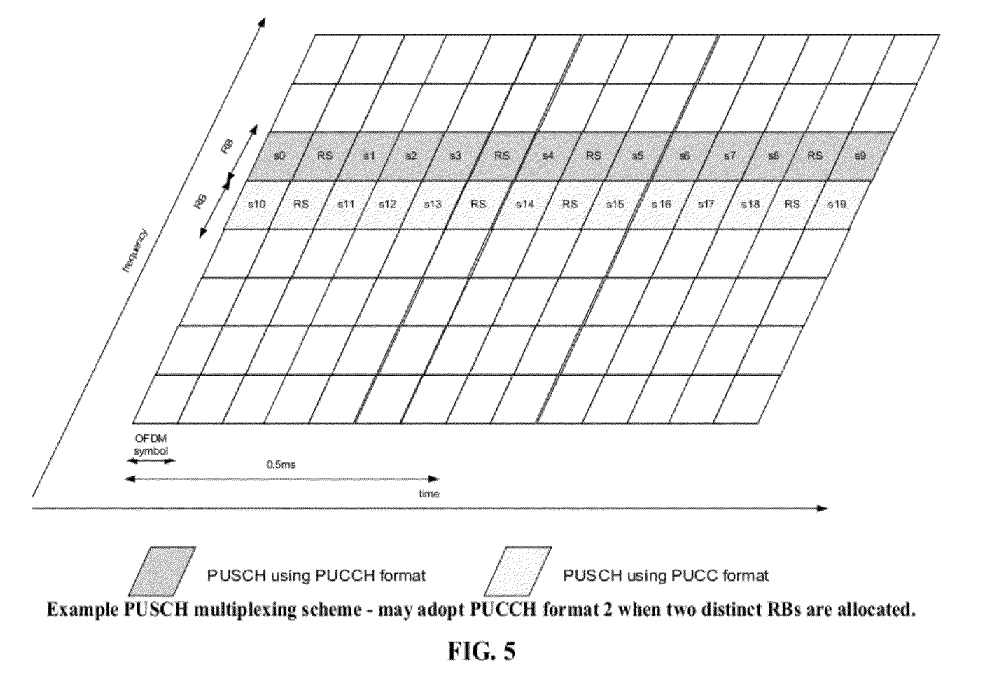

FIG. 6 is a diagram of an example DFT-S-OFDM based PUCCH consistent with embodiments;

FIG. 7 is a diagram of an example PUSCH multiplexing scheme consistent with embodiments;

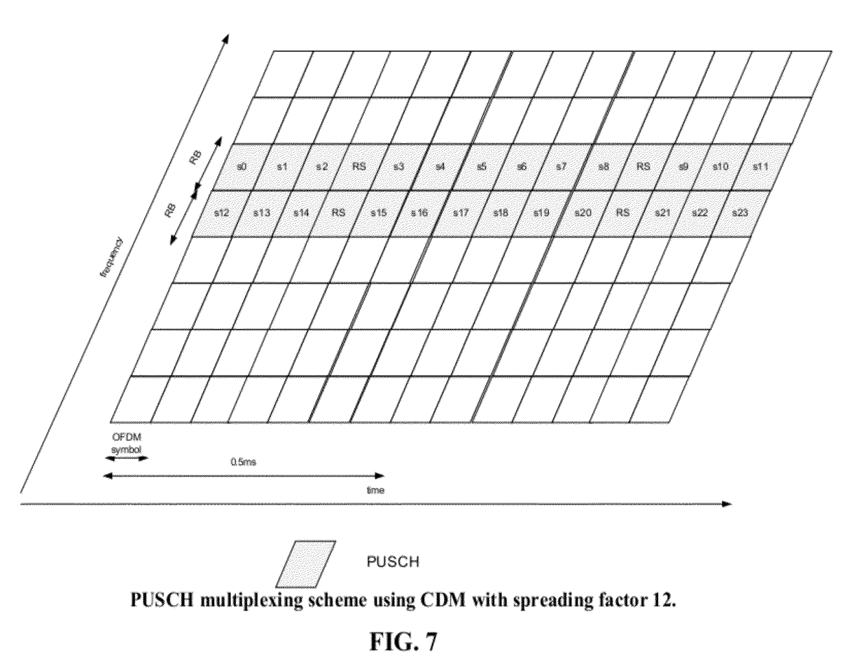

FIG. 8 is a diagram of an example PUSCH multiplexing scheme consistent with embodiments;

FIG. 9 is a diagram of an example PUSCH multiplexing scheme consistent with embodiments;

FIG. 10 is a diagram of an example PUSCH multiplexing scheme consistent with embodiments;

FIG. 11 is a diagram of an exemplary method consistent with embodiments for transmitting UCI data;

FIG. 12 is a diagram of an exemplary method consistent with embodiments for determining a UCI offset parameter;

FIG. 13 is a diagram of an exemplary method consistent with embodiments for adjusting the power level of a transmission that includes UCI;

FIG. 14 is a diagram of an exemplary method consistent with embodiments for selecting physical channel resources for a transmission that includes UCI; and

FIG. 15 is a diagram of an exemplary method consistent with embodiments for multiplexing data from multiple sources.

### DETAILED DESCRIPTION OF ILLUSTRATIVE EMBODIMENTS

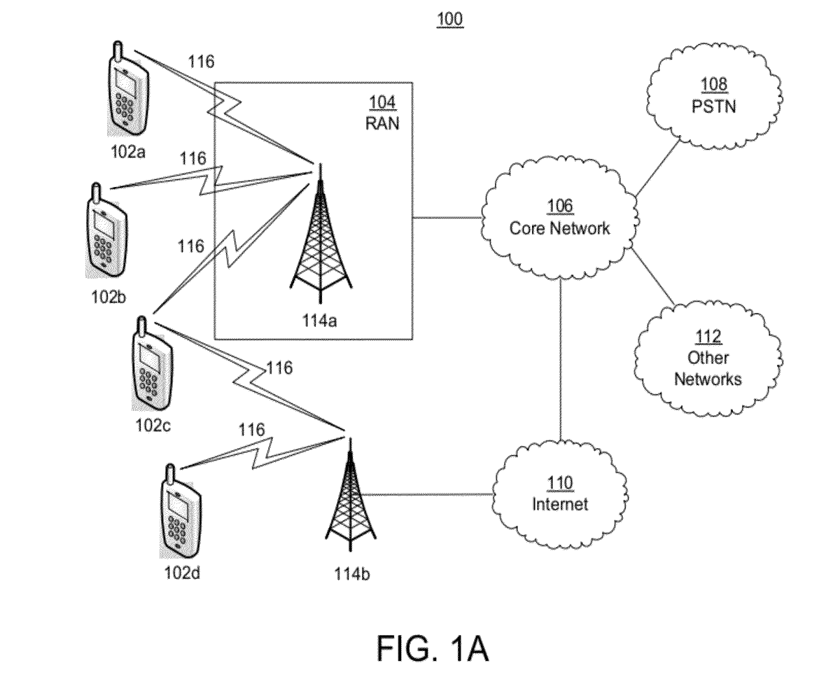

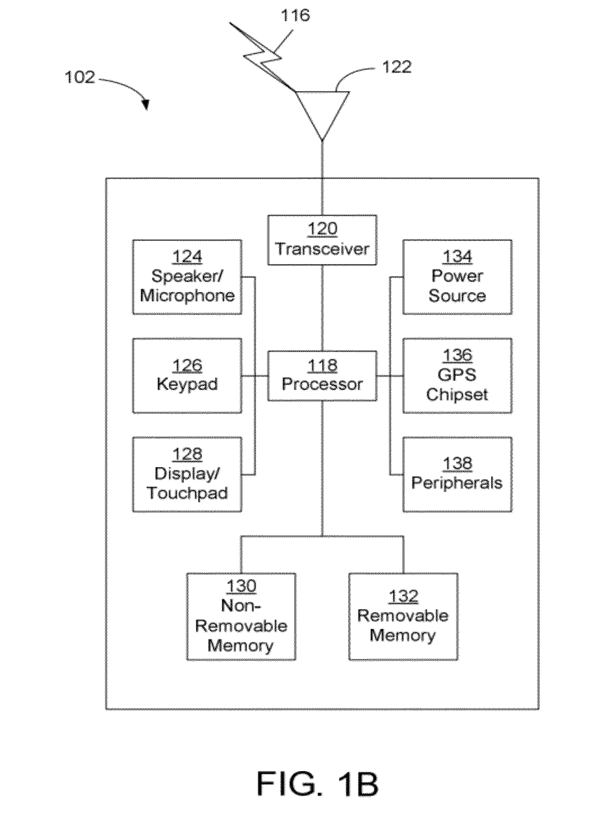

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

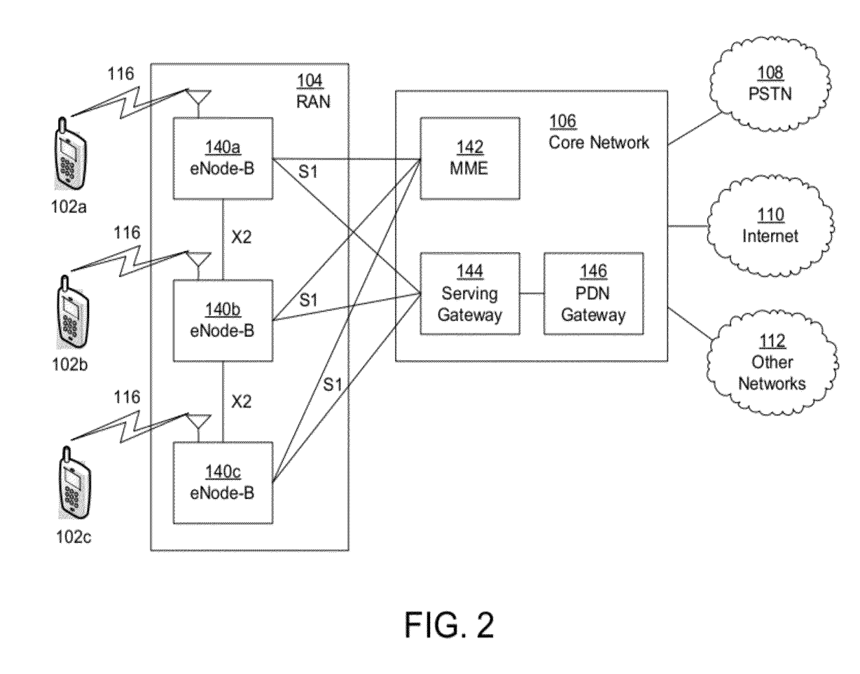

FIG. 2 is a system diagram of the RAN 104 and the core network 106 according to an embodiment. As noted above, the RAN 104 may employ an E-UTRA radio technology to communicate with the WTRUs 102a, 102b, and/or 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, and 140c may be associated with a particular cell (not shown) and may be configured to handle radio resource management decisions, handover decisions, scheduling of users in the uplink and/or downlink, and the like. As shown in FIG. 2, the eNode-Bs 140a, 140b, 140c may communicate with one another over an X2 interface.

The core network 106 shown in FIG. 2 may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, and/or 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of device capable of operating in a wireless environment. Likewise, as used herein, a UE may include a WTRU. When referred to hereafter, the terminology “base station” includes but is not limited to a Node-B, a site controller, an access point (AP), or any other type of interfacing device capable of operating in a wireless environment.

In wireless communication systems, such as in a Long Term Evolution (LTE) wireless system, the network may configure the User Equipment (UE)/wireless transmit/receive unit (WTRU) with uplink (UL) and downlink (DL) resources on a single uplink (UL) and single downlink (DL) carrier respectively. LTE Release 8/9 (LTE R8/R9) may support up to 100 Mbps in the DL, and 50 Mbps in the UL for a 2×2 configuration. The LTE DL transmission scheme may be based on an OFDMA air interface. For the purpose of flexible deployment, R8/R9 systems may support scalable transmission bandwidths, one of 1.4, 2.5, 5, 10, 15 or 20 MHz.

In LTE R8/R9, and also applicable to LTE Release 10 (R10), each radio frame (10 ms) may consist of 10 equally sized sub-frames of 1 ms, for example. Each sub-frame may be comprised of 2 equally sized timeslots of 0.5 ms each. There may be either 7 or 6 OFDM symbols per timeslot. 7 symbols per timeslot may be used with normal cyclic prefix length, and 6 symbols per timeslot may be used in an alternative system configuration with the extended cyclic prefix length. The sub-carrier spacing for the LTE R8/9 system may be 15 kHz, for example. An alternative reduced sub-carrier spacing mode using 7.5 kHz is also possible.

A resource element (RE) may correspond to approximately or precisely one (1) sub-carrier during one (1) OFDM symbol interval. 12 consecutive sub-carriers during a 0.5 ms timeslot may constitute one (1) resource block (RB). Therefore, with 7 symbols per timeslot, each RB may be comprised of 12×7=84 RE's, for example. A DL carrier may be comprised of a scalable number of resource blocks (RBs), by way of example ranging from a minimum of 6 RBs up to a maximum of 110 RBs. This may correspond to an overall scalable transmission bandwidth of roughly 1 MHz up to 20 MHz. A set of common transmission bandwidths may be specified, e.g. 1.4, 3, 5, 10 or 20 MHz.

The basic time-domain unit for dynamic scheduling may be one sub-frame consisting of two consecutive timeslots, for example. This may be referred to as a resource-block pair. Certain sub-carriers on some OFDM symbols may be allocated to carry pilot signals in the time-frequency grid. A given number of sub-carriers at the edges of the transmission bandwidth may not be transmitted in order to comply with spectral mask requirements.

In the R8/R9 LTE UL direction, the R8 LTE system may be based on DTF-S-OFDMA, or equivalently, SC-FDMA transmission. Whereas in the LTE DL direction a wireless transmit/receive unit (WTRU) may receive its signal anywhere across the frequency domain in the whole LTE transmission bandwidth (e.g., an OFDMA scheme may be used). For the UL a WTRU may transmit only on a limited, and perhaps contiguous, set of assigned sub-carriers in an FDMA arrangement (e.g., a set of frequency-consecutive sub-carriers). This principle may be referred to as Single Carrier (SC) FDMA.

In LTE R8/9 and also applicable to LTE R10, a Physical Downlink Control Channel (PDCCH) may be used by the network or eNB to assign Physical Downlink Shared Channel (PDSCH) resources for downlink transmissions and to grant Physical Uplink Shared Channel (PUSCH) resources for uplink transmissions to the terminal device or a wireless transmit/receive unit (WTRU).

The R8 PUCCH Type Ack/Nack had to carry 1 Ack/Nack bit (or, 2 in case of DL MIMO) maximum (FDD). R10 LTE FDD may need to accommodate up to 10-12 bits worth of Ack/Nack information in a PUCCH (corresponding to 2 TBs received per DL CC on up to 5 DL CC's). In R8 LTE, DTX (no DL PDSCH was detected or the DCI was missed) is implicitly encoded as absence/presence of the PUCCH itself.

For LTE R10, a WTRU may be configured with at least one UL/DL PCC pair, or primary cell (Pcell), and one or more SCC(s), (Secondary component carrier(s) or secondary cell(s) (Scell)), and with at least one PUCCH resource for transmission of Uplink Control Information (hereafter UCI) e.g. on its UL PCC. In any given subframe n+4, the WTRU may thus be expected to transmit UCI for more than one DL CC, including HARQ Ack/Nack feedback for one or more PDSCH transmissions that occurred in subframe n, and/or CQI/PMI/RI reports.

If a subframe n+4 for which the WTRU additionally has been granted at least one PUSCH resource, either by dynamic scheduling or from a configured allocation (i.e. a Semi-Persistent Scheduled (hereafter SPS) resource), a WTRU behavior for selecting which uplink transmission resource(s) may be used for UCI.

Embodiments contemplate that an UE/WTRU may operate with one or multiple carriers and may select uplink resources for the transmission of the UCI, perhaps in a subframe for which the WTRU has at least one PUSCH resource allocated.

In LTE-Advanced (LTE R10), support for different types of CCs may be included. When referred to hereafter, the term “primary component carrier (PCC)” includes, without loss of generality and by way of example and not limitation, a carrier of a UE configured to operate with multiple component carriers for which some functionality, such as e.g. derivation of security parameters and Non-Access Stratum (NAS) information, may be applicable to a number of component carriers or perhaps only to that component carrier. The UE may be configured with at least one PCC for the downlink (DL PCC) and at least one for the uplink (UL PCC). Consequently, a carrier which is not a PCC of the UE is hereafter referred to as a Secondary Component Carrier (SCC), by way of example.

The DL PCC may, for example, correspond to the CC used by the WTRU to derive initial security parameters when initially accessing the system.

The UL PCC may, for example, correspond to the CC whose PUCCH resources are configured to carry all HARQ A/N and Channel State Information (CSI) feedback for a given WTRU.

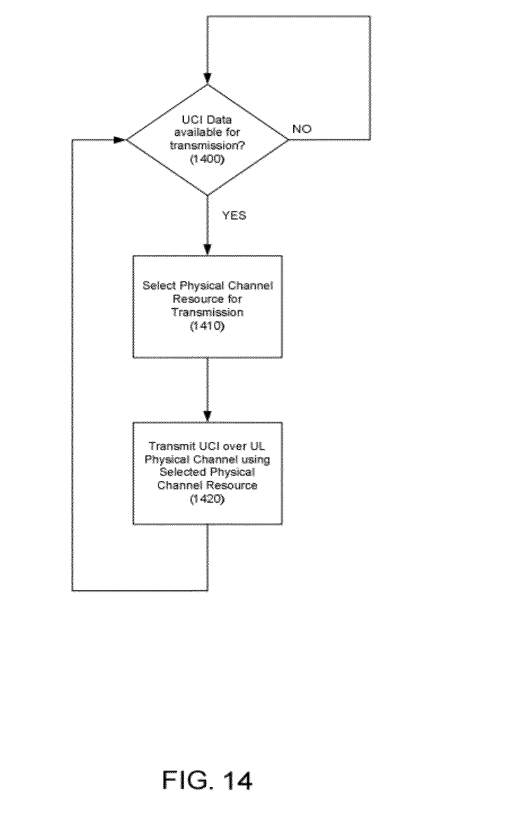

FIG. 14 illustrates an exemplary method for that may determine the physical channel resources for sending a transmission containing UCI. At 1400, it is determined, perhaps at the WRTU, whether there may be UCI data available for transmission. If it is determined that UCI can be transmitted, at 1410, physical channel resources can be determined to facilitate the transmission. The determination of the physical channel resources can depend on a variety of factors in various embodiments. In one exemplary embodiment, the physical channel resources could depend on the number of potential component carriers. Still in another embodiment, the physical channel resources could depend on the availability of a physical channel. In yet another embodiment, the selection of physical channel resources could depend on characteristics of a component carrier. In some embodiments the physical channel resource could be, for example, a PCC. Alternatively, embodiments contemplate that the physical channel resource could be a SCC. Additionally, the physical channel resource could be selected for a plurality of active CCs. At 1420, the physical channel resource selected at 1410 may be used to transmit the data which includes the UCI.

In LTE R8/9, for all dynamically scheduled PDSCHs, the PUCCH index to be used for transmission of the PUCCH Type 1/1a/1b is implicitly given through a first-CCE-of-the-DCI assignment rule. This is to avoid allocating semi-statically on a per-WTRU basis, a great number of PUCCH indices that are in practice seldom used in the same time, given that typically several up to 10 WTRUs only are assigned DL PDSCHs per subframe. Instead, PUCCH indices are dynamically assigned through a rule on a per-need basis. The R8 rule is that the first CCE in the PDCCH that contains the DL Control Message (DCI) announcing the PDSCH is used to compute the PUCCH index for transmitting the Ack/Nack (hereinafter “A/N”) signal, in conjunction with an RRC signaled offset to address the range of PUCCH type 1 RB's reserved in the system.

In LTE R8/9, for configured downlink assignments on PDSCH, i.e. semi-persistent scheduling (SPS), the WTRU is typically first configured by RRC with a PDSCH resource (e.g. a SPS-C-RNTI for de/activation, a periodic interval, or the number of HARQ processes for SPS) together with a set of up to four PUCCH resource indexes. The WTRU then monitors the PDCCH for an activation command, i.e. a DCI containing the details of the DL assignment (number of physical resource blocks, modulation and coding scheme, etc), upon which reception is kept as a configuration of a HARQ process; this activation command additionally includes an index to the PUCCH resource to be used for the HARQ A/N feedback transmission and is also kept in the WTRUs configuration. When decoding a transport block on PDSCH, which transport block corresponds to a SPS assignment, the WTRU sends Ack/Nack on the configured PUCCH resource in a subsequent subframe (typically n+4 for a transport block received in subframe n).

Another aspect to consider for SPS is the RRC configuration of a number of resources. Also, SPS activation indicates to the WTRU which resources are to be used.

R8 LTE, PUCCH Type 2 resources such as used for CQI/PMI/RI reports, are explicitly assigned to the WTRU by the network through RRC signaling, and these PUCCH Type 2 are contained in a distinct set of explicitly administered resources. Similarly, for R8 DL SPS transmissions, four PUCCH indices for PUCCH type 1 Ack/Nacks are explicitly signaled to the WTRU by means of RRC.

LTE-Advanced (LTE-A, or LTE R10) is an evolution to LTE that aims to improve LTE R8/R9 data rates using, among other methods, bandwidth extensions, or Carrier Aggregation (CA). With CA, the WTRU may transmit and receive simultaneously over the PUSCH and the PDSCH respectively of multiple Component Carriers (CCs); up to five CCs in the UL and in the DL may be used and thus supporting flexible bandwidth assignments up to 100 MHz.

The control information for the scheduling of PDSCH and PUSCH may be sent on one or more PDCCHs; in addition to the LTE R8/9 scheduling using one PDCCH for a pair of UL and DL carriers, cross-carrier scheduling may also be supported for a given PDCCH, allowing the network to provide PDSCH assignments and/or PUSCH grants for other component carriers.

Embodiments contemplate that the DL PCC may, for example, correspond to the CC used by the UE to derive initial security parameters when initially accessing the system. Also, the UL PCC may, for example, correspond to the CC whose PUCCH resources are configured to carry all HARQ A/N and Channel State Information (CSI) feedback for a given UE.

A cell of a UE may consist in a DL CC and, potentially, be combined with a set of UL resources e.g. a UL CC. For LTE R10, the Primary Cell (hereafter PCell) may consist in a combination of DL PCC and a UL PCC. A Secondary Cell (hereafter SCell) of the UE's multicarrier configuration may consist in a DL SCC, and, alternatively, a UL SCC (e.g., asymmetric configurations, where a UE is configured with more DL CCs than UL CCs, may be supported in LTE R10). For LTE R10, the UE's multicarrier configuration may include one PCell and up to 4 SCells, or more, for example.

LTE R8 PUCCH Type A/N may only have had to carry 1 A/N bit (or, 2 in case of DL MIMO) maximum (FDD). R10 LTE FDD may be required to accommodate up to 10-12 bits worth of A/N information in a PUCCH (corresponding to 2 TB's received per DL CC on up to 5 DL CC's, for example). Embodiments contemplate that in R8 LTE, DTX (“no DL PDSCH was detected or the DCI was missed”) may have been implicitly encoded as absence/presence of the PUCCH itself.

Embodiments Contemplate that power scaling for UL transmissions may include the following: power scaling in case of power limitation; PUSCH with UCI may be prioritized over PUSCH without UCI (i.e. power of PUSCH without UCI may be scaled down first, maybe to zero, for example), a priority order may be as follows: PUCCH>PUSCH with UCI>PUSCH without UCI, for example. Also, Prioritization may be regardless of same or different CCs. Embodiments also contemplate transmitting PUCCH and PUSCH with UCI either simultaneously or non-simultaneously.

For LTE R10, a UE may support a transmission mode similar to R8/9 which may restrict the UE to single channel uplink transmissions for a given UL carrier (hereafter referred to as SC mode) where simultaneous transmission over PUCCH and PUSCH (on same or different carriers) may not be supported. Alternatively, a transmission mode by which the UE may support simultaneous transmissions on PUCCH and PUSCH may be configured for a UE supporting such mode of operation (hereafter referred to as PUCCH+PUSCH mode).

Embodiments contemplate that the PUCCH+PUSCH transmission mode may be supported for LTE R10. Embodiments also contemplate that the UE may not transmit simultaneously on PUCCH and PUSCH, independently of whether the transmission is performed in the same UL CC or not.

Embodiments contemplate that, for LTE R10, a WTRU may be configured with at least one UL/DL PCC pair and one or more SCC(s), and with at least one PUCCH resource for transmission of Uplink Control Information (hereafter UCI) e.g., on its UL PCC. In any given subframe n+4, the WTRU may thus be expected to transmit UCI for more than one DL CC, including HARQ Ack/Nack feedback for one or more PDSCH transmissions that may have occurred in subframe n, and/or CQI/PMI/RI reports, for example.

Embodiments contemplate that, for LTE R10, for any given subframe, the UE may have PUCCH resource available for transmission of UCI and may additionally be granted PUSCH resources for a transmission on more than one UL CC.

By way of example, for a subframe n+4 for which the UE may have been granted at least one PUSCH resource, either by dynamic scheduling or from a configured allocation, i.e. a Semi-Persistent Scheduled (hereafter SPS) resource, a UE behavior may be useful for selecting which uplink transmission resource(s) may be used for UCI. Embodiments contemplate that a deterministic UE behavior may allow the NW to determine which part of the PUSCH transmission may consist of UCI, such that it may properly decode the PUSCH transmission. In other words, embodiments contemplate how a Rel-10 UE configured for multicarrier operation may select the UL resource for the transmission of UCI, perhaps in a subframe for which the UE has at least one PUSCH resource allocated, for example.

In addition, embodiments contemplate that there may be one or dependencies related to the uplink transmission mode supported and/or configured by the UE (e.g., either SC mode and/or PUCCH+PUSCH mode), and the relative priority between different types of UCI (e.g. HARQ A/N, SR, CQI/PMI/RI in decreasing priority order, for example) may also be considered.

Embodiments contemplate that an R10 WTRU configured for multicarrier operation may select a UL resource for the transmission of UCI, perhaps in a subframe for which the WTRU has at least one PUSCH resource allocated.

Embodiments contemplate that a WTRU may be configured for multicarrier operation (i.e. carrier aggregation). The disclosed embodiments may be applicable to a LTE R10 WTRU, without restricting the embodiments described or to a specific technology. For example, embodiments contemplate that a WTRU may be configured with multiple DL carriers, e.g., with at least one DL SCC, or that a WTRU may have a valid PUCCH configuration on its UL PCC; or that a WTRU may be expected to transmit UCI information (e.g., in subframe n+4 for FDD). Embodiments also contemplate which UCI information may include at least one of: HARQ A/N feedback for at least one DCI carrying control signaling (e.g. for SPS de/activation) and/or at least one PDSCH transmission (decoded in subframe n); CQI/PMI/RI reports (periodic or aperiodic, for example); a Scheduling Request (SR).

Embodiments also contemplate that a UE/WTRU may have at least one resource allocated for an uplink transmission, e.g. the UE/WTRU may have successfully decoded at least one grant for an uplink transmission on a PUSCH (dynamically allocated and/or configured) and/or may have resources for a non-adaptive retransmission on at least on PUSCH.

The embodiments contemplate that a Rel-10 UE/WTRU may have a multicarrier configuration, whether the UE/WTRU operates using a SC mode or a PUCCH+PUSCH mode, for example.

More generally, for a subframe for which the UE may transmit UCI, embodiments contemplate that a UE/WTRU may, if the UE may operate using a SC mode and if the UE may have at least one PUSCH resource available for an uplink transmission, the UE may select a PUSCH resource for UCI transmission.

Alternatively, embodiments contemplate that if the UE may operate using a PUCCH+PUSCH mode, the UE may perform at least one of the following: the UE may transmit at least part of the UCI (e.g. UCI with higher priority such as HARQ A/N, SR) on a PUCCH resource, on either: a configured Rel-10 resource e.g. on the UL PCC, if configured; or a UL CC linked with the DL CC for which the UCI may be otherwise applicable.

Additionally, embodiments contemplate that if the UE may have at least one PUSCH resource available for an uplink transmission, the UE may transmit at least part of the UCI (e.g. UCI of lower priority such as CQI/PMI/RI) on a PUSCH resource.

Embodiments contemplate that a UE may, possibly dynamically, determine what resource of which UL CC to use for the transmission of UCI among the available resources in a given subframe, using at least one of the following principles (the names of which are provided for illustrative purposes and not meant to be limiting): Random Selection, wherein the UE may select randomly among a number of UL CCs; Priority-Based Selection, wherein the UE may select a UL CC based on a priority criteria; Semi-Static Selection, wherein the UE may use resources of a pre-determined UL CC, such as a configured UL CC or a UL PCC, and/or a configured UL CC or a UL PCC occasionally or perhaps always; and/or Explicit Selection, wherein the UE may selects a UL CC explicitly signaled by the NW.

Embodiments may also consider Pairing-Based Selection, wherein the UE may select a UL CC that may not be used for transmission of UCI pertaining to different UL/DL CC pair; Channel Quality Based Selection, wherein the UE may select a UL CC as a function of one or more specific characteristics of the allocated PUSCH resource, including one or more the following, for example:

resources that may be allocated for the transmission on PUSCH, either possibly as a function of the number of RBs allocated for the PUSCH transmission, e.g. the UE selects the PUSCH with the highest number of RBs, and/or possibly as a function of the MCS allocated for the PUSCH transmission, e.g. the UE selects the PUSCH with the most conservative MCS or alternatively the least conservative MCS;

the power headroom that may be available for the transmission on PUSCH;

the available transmission power for the transmission on PUSCH; and/or

the pathloss of the associated DL CC.

Embodiments contemplate that feedback pertaining to certain downlink shared channels (including but not limited to HARQ ACK/NACK, CQI, PMI and RI, for example) as well as other control information such as SR may be transmitted on different UL CCs. The UL CC may be selected on a dynamic basis among the UL CC(s) for which transmission resources may be available in a given subframe. For example, feedback for a given DL-SCH may be transmitted from the PUCCH of a given UL CC in case no PUSCH transmission takes place on any UL CC in a given subframe, while in case PUSCH transmission takes place on at least one UL CC, feedback may be provided on the PUSCH of at least one of these UL CC.

Embodiments contemplate that the selection of the UL CC that may be used for transmission of this information in a given sub-frame may be performed according to at least one of the following techniques.

Embodiments contemplate Random Selection—wherein the UE may select randomly the PUSCH resource, perhaps among a configured set of UL CC. For the purpose of transmitting at least part of the UCI on a PUSCH transmission, the UE/WTRU may randomly select a UL CC for which a PUSCH allocation may be available.

Embodiments contemplate Priority-Based Selection—wherein the UE may select the PUSCH resource according to a given priority associated to UL CCs. For the purpose of transmitting at least part of the UCI on a PUSCH transmission, the UE may select a UL CC following a priority criterion, e.g. at least one of the following:

the type of CC (i.e. PCell or SCell) for which a PUSCH grant may be available; and/or

a priority order either derived implicitly, e.g. based on CC center frequency, allocated/configured cell identifier, grant received in a DCI with lowest CCE value and/or highest aggregation level (e.g. if cross-carrier scheduling is used) or either explicitly configured.

For example, embodiments contemplate that a priority ordering may be such that the UE selects the UL PCC if a PUSCH allocation may be available for that CC. Otherwise the UE may select a UL SCC with a PUSCH allocation available (possibly according to any other embodiment described herein). Should no PUSCH be available then the UE may select the PUCCH on UL PCC, for example. Alternatively, embodiments contemplate the Priority-Based Selection may be limited to cases of absence of explicit signaling by the network for the selection of the UL CC. Alternatively, embodiments contemplate that the UL CCs may be ranked by order by preference (such ranking may be signaled by higher layers).

Embodiments contemplate Semi-Static Selection—wherein the UE may select a UL resource corresponding to a predetermined UL CC (e.g. PCC) for which a PUSCH resource may be available for an uplink transmission in the subframe. Embodiments contemplate that, in case there is no UL CC transmitting a PUSCH transmission in the subframe, the information may be transmitted on the PUCCH of a predetermined UL CC (that may be signaled by higher layers, for example).

Embodiments contemplate that when the UE/WTRU may operate with SC mode:

if the UE has a PUSCH allocation for the UL PCC, the UE may transmit at least parts of the UCI on that PUSCH transmission, else the UE may perform at least one of the following:

the UE may transmit at least parts of the UCI on the PUCCH of the UL PCC, e.g. at least the UCI with higher priority such as HARQ A/N and/or SR;

the UE may ignore any other PUSCH transmission (e.g., the UE may not make a transmission for one or more grant(s) for a UL SCC) in the subframe; and/or

the UE may refrain from transmission of some of the UCI, e.g. UCI with lower priority such as CQI/PMI/RI.

Embodiments also contemplate that when the UE may operate with PUCCH+PUSCH mode:

if the UE has a PUSCH allocation for the UL PCC, the UE may transmit at least parts of the UCI on that PUSCH transmission, else the UE may perform at least one of the following:

the UE may transmit at least parts of the UCI on the PUCCH of the UL PCC, e.g. UCI with higher priority such as HARQ A/N and/or SR;

for the purpose of transmitting at least part of the UCI, the UE may not consider other possible PUSCH allocation(s) (e.g., one or more grant(s) for a UL SCC) in the subframe; and/or

the UE may refrain from transmission of some of the UCI, e.g. UCI with lower priority such as CQI/PMI/RI.

Alternatively, embodiments contemplate that the UE may consider a PUSCH allocation on a CC different than the UL PCC for at least part of the UCI, e.g. for transmission of UCI with lower priority such as CQI/PMI/RI. The UE may determine which of the UL SCC to using techniques described herein.

Embodiments contemplate Explicit Selection—wherein the UE may select a UL CC that may be explicitly signaled by the NW, e.g. within the L1 signaling (PDCCH) used for granting the UL resource. For example, if the UE receives a request for transmission of aperiodic UCI such as aperiodic CQI request in a DCI message on a PDCCH, the UE may transmit UCI (either all UCI for the subframe, or the requested UCI, e.g. the aperiodic CQI) on the PUSCH corresponding to at least one of the following:

the PDCCH on which the request may have been received (from UL/DL linking e.g. based on SIB2), e.g. the PUSCH is addressed by the grant received on the PDCCH;

the UE-specific search space in which the PDCCH of the request may have been received (from UL/DL linking e.g. based on SIB2);

the CIF for which the DCI message may be applicable to (possibly from the UL/DL linking, e.g. based on SIB2); and/or

an explicit indication in the request, if any.

Alternatively, embodiments contemplate that the explicit selection may be limited to cases in which there may be no PUSCH transmission on the UL PCC.

Embodiments contemplate Pairing-Based Selection—wherein the UE may select a UL resource corresponding to a UL CC that may not be configured for transmission of UCI for a DL CC that may be different than the DL CC linked to the UL CC, if any.

Alternatively, the information may be transmitted on the PUCCH of an UL CC which may not already be used for providing feedback for another DL-SCH, if such UL CC may be available. Embodiments also contemplate that the use of the PUCCH for a certain UL CC may be ruled by setting a ranking between different DL-SCH that may have to use it. In case there may be no UL CC for which the PUCCH is not already used by another DL-SCH, the information may be multiplexed with the information pertaining to the other DL-SCH on the same PUCCH of an UL CC, for example.

Embodiments contemplate Channel Quality Based Selection—wherein the UE may select a UL CC as a function of a specific characteristic of the PUSCH transmission, including at least one of the following:

the resources may be allocated for the transmission on PUSCH, possibly as a function of the number of RBs that may be allocated for the PUSCH transmission, e.g. the UE selects the PUSCH with the highest number of RBs; and/or possibly as a function of the MCS allocated for the PUSCH transmission, e.g. the UE may select the PUSCH with the most conservative MCS or alternatively the least conservative MCS, for example;

the power headroom that may be available for the transmission on PUSCH, e.g. the UE selects the PUSCH with the highest available headroom; and/or

the available transmission power for the transmission on PUSCH, e.g. the UE may select the PUSCH with the highest available transmission power, for example. Embodiments contemplate that transmission power on PUSCH may itself be a function of the DL pathloss, the number of RBs, the MCS for the transmission, and/or the accumulated received power commands, for example. Regarding the pathloss of the associated DL CC, the UE may select the PUSCH with the lowest pathloss for the DL CC that may be used as the pathloss reference.

Embodiments contemplate that, for one or more of the previously described techniques, the set of UL CCs that may be considered by the selection technique may be a restricted set of UL CCs of the UE's multicarrier configuration, which set may be signaled by higher layers (e.g. RRC) as part of a semi-static configuration of the UE. In addition, the UE may consider the size of the PUSCH allocation. For example, if the size of the payload for the transmission on the selected PUSCH may be insufficient to transmit all UCI, the UE may perform at least one of the following:

the UE may drop at least part of the UCI, e.g. the UE may transmit on PUSCH the UCI with higher priority such as HARQ A/N does not consider other UCI for transmission in this subframe;

the UE may select a different PUSCH for transmission of UCI according to embodiments described herein, for example by utilizing one of these embodiments but excluding the UL CC for which the PUSCH allocation is insufficient; and/or

if configured with PUCCH+PUSCH mode, the UE may transmit part of the UCI on PUCCH and the remainder on the PUSCH (if possible), e.g. the UE transmits on PUCCH the UCI with higher priority such as HARQ A/N, and transmits other UCI on PUSCH, for example.

Alternatively, embodiments contemplate that the UE may refrain from transmission of at least part of the UCI on a configured PUSCH allocation (e.g., SPS grant). For example, the UE may refrain from transmitting UCI with lower priority such as CQI/PMI/RI using the configured PUSCH resource.

Embodiments contemplate that, for a given subframe n+4 for example, the UE/WTRU may select an uplink radio resource, which may be at least one of (by way of example and not limitation):
an UL CC (e.g. a UL PCC, perhaps with R10 PUCCH) with a PUCCH resource that may be configured for the transmission of R10 UCI;
an UL CC (e.g., either a UL PCC and/or a UL SCC that may use R8/9 PUCCH principles) with a PUCCH resource that may be dynamically selected by the WTRU based on, at least in part, the control signaling received in subframe n, perhaps per Rel-8/9 principles, for example; and/or
an UL CC (e.g., either a UL PCC and/or a UL SCC that may use PUSCH resources) with a PUSCH resource that may be granted for an uplink transmission in the subframe n+4, which PUSCH resource may be either dynamically scheduled e.g. from control signaling (e.g. PDCCH) received in subframe n, or configured using semi-persistent scheduling.

Embodiments contemplate that the selection of a uplink radio resource may be function of at least one of:
whether or not the WTRU may have a valid PUCCH configuration (e.g. a Rel-10 PUCCH resource). For example, if not, the WTRU may have a single UL CC available and may dynamically select a resource, perhaps using R8/9 principles. Again by way of example, if a timing advance timer (TAT) expires, the WTRU may release the R10 HARQ A/N resources and may revert to R8/9 behavior;
the amount of UCI, for example, whether the UCI may correspond to a single DL CC or multiple DL CCs. For example, in case of a single UCI, the WTRU may dynamically select a resource, perhaps using Rel-8/9 principles, either in a PCC or, alternatively, in the SCC that may correspond to the received control signaling on PDCCH; and/or
The number of PUSCH allocation(s) (e.g. grants) for a transmission in subframe n+4. More specifically:
   whether there may be no PUSCH allocation, in which case, for example, the WTRU may select a PUCCH resource, possibly in a PCC, or alternatively, in the SCC that corresponds to the received control signaling on PDCCH. Alternatively, embodiments contemplate that the WTRU may select a PUCCH resource exclusively (or always) in a PCC;
   whether there may be a single PUSCH allocation, in which case for example, the WTRU may select the UL CC that may correspond to the PUSCH resource and may transmit UCI on the PUSCH allocation; and/or
   whether there may be multiple PUSCH allocations, in which case, for example, the WTRU may select at least one of the PUSCH resource according to one or more of the uplink radio resource selection techniques disclosed herein, possibly in combination.

Alternatively, embodiments contemplate that selection of an uplink radio resource may be function of whether the PUSCH allocation may be for a transmission that may have a specific characteristic. More specifically, embodiments contemplate whether the allocation may correspond, for example, at least to the number of Physical Resource Blocks (PRBs) (or alternatively the number of Resource Elements (REs). As an example, if the WTRU is power limited, the WTRU may select the PUSCH with perhaps the smallest number of PRBs (or REs) that may be sufficient for transmission of UCI information or a prioritized subset thereof such as HARQ ACK/NACK, CQI, etc. Otherwise, the WTRU may select the PUSCH with the highest number of PRBs.

Embodiments contemplate that a WTRU may scale down the transmission power for transmissions a UL CC for which there is no UCI information. The WTRU may perform the power scaling between some or all uplink transmissions of a subframe after the WTRU may have determined which PUSCH to use for the transmission of UCI, if any, for. For example, by including the UCI on the PUSCH with the smallest number of resources that can accommodate the UCI and scaling down the power of other uplink transmissions, if any and if needed, then the WTRU may effectively prioritize the transmission of the UCI.

Alternatively, embodiments contemplate whether the allocation may correspond to at least one of:

a number of coded symbols for UCI transmission, Q′, which, for example, may be based on one or more of the formulas 1-12, described below;

on a betaOffset of the PUSCH configuration, β_{offset}^{PUSCH}, which may be provided by higher layers and is described below;

an initial number of SC-FDMA symbols for the corresponding transport block (e.g. the PUSCH with the largest number, for example);

an UL PCC of the WTRU configuration (e.g. using RRC configuration);

an UL CC with a configured PUCCH resource (e.g. a R10 PUCCH resource);

an UL SCC of the WTRU configuration (e.g. using RRC configuration);

an UL CC that may be configured with higher or absolute priority (e.g. using RRC configuration); and/or

an indication, perhaps in the control signaling (e.g. either L1/PDCCH, or L2 MAC, or L3 RRC), that the allocation may be used for transmission of UCI.

Alternatively, embodiments contemplate that selection of an uplink radio resource may be function of whether or not the WTRU may have a valid PUCCH configuration for HARQ ACK/NACK for a semi-persistent transmission on PDSCH (e.g., if configured, using an index to one of up to four or more resources).

Alternatively, embodiments contemplate that selection of an uplink radio resource may be function of whether the UCI may correspond to the HARQ A/N of a configured PDSCH assignment or may correspond to only the HARQ A/N of a configured PDSCH assignment. In which case, for example, the UE may use the corresponding PUCCH resource configured for transmission of HARQ A/N feedback for the semi-persistent allocation.

Alternatively, embodiments contemplate that selection of an uplink radio resource may be function of whether or not the WTRU may have a valid pathloss reference for an uplink transmission in subframe n+4. For example, for the UL CC, in case the pathloss reference may not valid, the WTRU may not consider the corresponding resource.

Alternatively, embodiments contemplate that selection of an uplink radio resource may be function of the measured pathloss for the DL CC that may be used as reference for the UL CC for an uplink transmission in subframe n+4 (e.g. the PUSCH with the smallest pathloss).

Alternatively, embodiments contemplate that selection of an uplink radio resource may be function of the uplink power that may correspond to the transmission for the UCI, for example, the UL CC with at least one of

the maximum PUSCH transmission power (e.g. the UL CC with highest value in subframe n+4);

the maximum PUCCH transmission power (e.g. the UL CC with highest value in subframe n+4);

the maximum transmission power that may be allowed (e.g. the UL CC with highest value in subframe n+4);

the available PUSCH power headroom (e.g. the UL CC with highest value in subframe n+4);

the available PUCCH power headroom (e.g. the UL CC with highest value in subframe n+4); and/or

the total available power headroom (e.g. the UL CC with highest value in subframe n+4).

Alternatively, embodiments contemplate that selection of an uplink radio resource may be function of whether or not the WTRU may have valid Timing Alignment (TA) for an uplink transmission in subframe n+4. More specifically, for the UL CC, in case the TA may not be valid for example, the UE may not consider the corresponding resource. Alternatively, embodiments contemplate that selection of an uplink radio resource may be function of whether the UCI may correspond to a DL PCC or a DL SCC of the WTRU configuration, or both. For example, in case the UCI may be solely for a DL PCC, the UE may dynamically select a resource using Rel-8/9 principles.

Alternatively, embodiments contemplate that selection of an uplink radio resource may be function of one or more a properties of the control signaling that may correspond to the PUSCH allocation, for example at least one of:

the UL CC selected may be the UL CC linked with the DL CC on which the PDDCH that may correspond to the PUSCH allocation may be successfully decoded;

based on a specific priority order, for example either based on a configuration of the WTRU or based on whether or not the DL CC is a DL PCC (e.g. PUSCH allocation received on a DL PCC may have higher priority in the selected method); and/or

based on the order or the position (e.g. the CCE index) of the DCI on the PDCCH.

Embodiments contemplate that which of the uplink radio resources described herein that may be used for the transmission of UCI may correspond to at least one DL CC and may include at least one of:

a CQI/PMI/RI report; and/or

a HARQ ACK/NACK feedback, e.g. for a PDSCH transmission that may be received in a previous subframe n.

Embodiments contemplate dynamic selection of PUCCH resource for HARQ A/N according to R8/9 signaling may be based on one of:

the first CCE of the DCI format that indicated the dynamic PDSCH allocation; and/or

an index to configured resources for a configured PDSCH allocation using semi-persistent scheduling.

Embodiments contemplate that the UE/WTRU may, if for a given subframe n+4 the WTRU may have to transmit UCI, and the WTRU may have a valid configuration including at least one DL SCC and a PUCCH resource for Rel-10 UCI (e.g., UCI for more than one DL CC), the UE may select a resource such that UCI may be transmitted on a UL PCC (perhaps in an alternative embodiment either occasionally or always on a UL PCC) either on PUSCH, if a PUSCH resource on the UL PCC may be available in the subframe, or on PUCCH otherwise, for example. Embodiments further contemplate that a UE/WTRU may support simultaneous transmissions on PUCCH and PUSCH, and if simultaneous transmissions on PUCCH and PUSCH may be supported it may be either in the same or in different UL CCs, for example. Embodiments also contemplate that the UE/WTRU may not support simultaneous PUCCH/PUSCH transmissions and/or there may be no resources granted for a PUSCH transmission on a UL SCC, for example.

Embodiments contemplate that, for PUCCH:

the SPS configured PUCCH resource may be selected, if configured and/or if HARQ A/N UCI may be for an SPS DL assignment in subframe n (in an alternative embodiment, if HARQ A/N UCI may only be for an SPS DL assignment in subframe n);

ignoring PUSCH allocations in one or any SCCs, to perhaps avoid simultaneous transmission on PUCCH in a PCC and PUSCH in a SCC; and/or

transmitting some (a part of) or all of UCI that may correspond to UCI of higher priority, e.g. HARQ A/N and/or SR.

Alternatively, embodiments contemplate that the UE/WTRU may, if for a given subframe n+4 the WTRU may have to transmit UCI, and the WTRU may not have a valid configuration including at least one DL SCC and/or a PUCCH resource for Rel-10 UCI (e.g., UCI for more than one DL CC) and the WTRU may have one or more UL CCs available (perhaps in an alternative embodiment only a single UL CC available), then the UE/WTRU may dynamically select a resource using R8/9 principles.

Alternatively, embodiments contemplate that the UE/WTRU may, if for a given subframe n+4 the WTRU may have to transmit UCI, and the WTRU may have a valid configuration including at least one DL SCC and a PUCCH resource for Rel-10 UCI (e.g., UCI for more than one DL CC), the UE may select a resource such that UCI may be transmitted either on PUSCH of any UL CC, if a PUSCH resource may be available in the subframe, or otherwise on PUCCH. If a PUSCH resource may be available in the subframe (for example):

selected randomly among some or all available PUSCH resources; or

selecting a PUSCH on a UL PCC if available, and perhaps randomly otherwise.

Embodiments contemplate that, for PUCCH, an SPS configured PUCCH resource may be selected, if configured and/or if HARQ A/N UCI may be for an SPS DL assignment in subframe n (in an alternative embodiment, if HARQ A/N UCI may only be for an SPS DL assignment in subframe n).

Alternatively, embodiments contemplate that the UE/WTRU may, if for a given subframe n+4 the WTRU may have to transmit UCI, and the WTRU may have a valid configuration including at least one DL SCC and a PUCCH resource for Rel-10 UCI (e.g., UCI for more than one DL CC), the UE/WTRU may select a resource such that UCI may be transmitted either on PUSCH and/or PUCCH. Embodiments contemplate transmitting on the PUSCH of the UL CC which PUSCH resource may have the largest number of available coded symbols applicable to the UCI transmission, if a PUSCH resource may be available in the subframe, or on PUCCH otherwise. Embodiments further contemplate that a UE/WTRU may support simultaneous transmissions on PUCCH and PUSCH. Embodiments also contemplate that the UE/WTRU may not support simultaneous PUCCH/PUSCH transmissions and/or there may be no resources granted for a PUSCH transmission on a UL PCC, for example.

For PUCCH, embodiments contemplate the SPS configured PUCCH resource may be selected, if configured and/or if HARQ A/N UCI may be for an SPS DL assignment in subframe n (in an alternative embodiment, if HARQ A/N UCI may only be for an SPS DL assignment in subframe n).

Alternatively, embodiments contemplate that the UE/WTRU may, if for a given subframe n+4 the WTRU may have to transmit UCI, and the WTRU may have a valid configuration including at least one DL SCC and a PUCCH resource for Rel-10 UCI (e.g., UCI for more than one DL CC), the UE/WTRU may select a resource such that UCI may be transmitted either on PUSCH and/or PUCCH. Embodiments contemplate transmitting on the PUSCH of the UL CC which PUSCH resource that may correspond to an indication in the control signaling applicable to the PUSCH resource, for example a field in a DCI signaling an uplink grant successfully decoded by the WTRU in subframe n, if a PUSCH resource may be available in the subframe, or on a PUCCH otherwise. For PUCCH, embodiments contemplate the SPS configured PUCCH resource, if configured and if HARQ A/N UCI may be for an SPS DL assignment in subframe n (in an alternative embodiment, if HARQ UCI may only be for an SPS DL assignment in subframe n).

Alternatively, embodiments contemplate that the UE/WTRU may, if for a given subframe n+4 the WTRU may have to transmit UCI, and the WTRU may not have a valid configuration including at least one DL SCC and/or a PUCCH resource for Rel-10 UCI (e.g., UCI for more than one DL CC), then the UE/WTRU may dynamically select a resource using R8/9 principles.

In LTE, transmissions on the uplink may be performed using Single Carrier Frequency Division Multiple Access (SC-FDMA). In particular, the SC-FDMA that may be used in the LTE uplink may be based on Discrete Fourier Transform Spread Orthogonal Frequency Division Multiplexing (DFT-S-OFDM) technology. As used hereafter, the terms SC-FDMA and DFT-S-OFDM are used interchangeably.

In LTE, a wireless transmit/receive unit (WTRU), alternatively referred to as a user equipment (UE), may transmit on the uplink using only a limited, contiguous set of assigned sub-carriers in a Frequency Division Multiple Access (FDMA) arrangement. For example, if the overall Orthogonal Frequency Division Multiplexing (OFDM) signal or system bandwidth in the uplink is composed of useful sub-carriers numbered 1 to 100, a first given WTRU may be assigned to transmit on sub-carriers 1-12, a second WTRU may be assigned to transmit on sub-carriers 13-24, and so on. While the different WTRUs may each transmit into only a subset of the available transmission bandwidth, an evolved Node-B (eNodeB) serving the WTRUs may receive the composite uplink signal across the entire transmission bandwidth. In LTE, uplink control information may be transmitted using a Physical Uplink Shared Channel (PUSCH) and/or a Physical Uplink Control Channel (PUCCH)

LTE Advanced (which may include LTE Release 10 (R10) and may include future releases such as Release 11, also referred to herein as LTE-A, LTE R10, or R10-LTE) is an enhancement of the LTE standard that may provide a fully-compliant 4G upgrade path for LTE and 3G networks. In LTE-A, carrier aggregation my be supported, and, perhaps unlike in LTE, multiple carriers may be assigned to the uplink, downlink, or both.

In both LTE and LTE-A, it may be useful for certain associated layer 1/layer 2 (L1/2) uplink control information (UCI) to support the uplink (UL) transmission, downlink (DL) transmission, scheduling, multiple-input multiple-output (MIMO), etc. In LTE, if a WTRU has not been assigned an uplink resource for UL transmission, such as a Physical UL Shared Channel (PUSCH), then the L1/2 UCI may be transmitted in a UL resource specially assigned for UL L1/2 control on a physical uplink control channel (PUCCH). Embodiments contemplate systems and methods that may transmit UCI for the multiple downlink component carriers (DL CCs) that may be enabled in LTE-A. Additionally, embodiments contemplate systems and methods for transmitting UCI and other control signaling utilizing PUSCH, as well as systems and methods that may take advantage of the other capabilities available in an LTE-A system for uplink control signaling.

The uplink control channel design for LTE Releases 8 and 9 (LTE R8/9) may include at least two transmission methods, both of which may use Single-Carrier Frequency Division Multiple Access (SC-FDMA), for the transmission of control signaling. Embodiments contemplate that control signaling may be transmitted using the Physical Uplink Shared Channel (PUSCH) by multiplexing control signaling with uplink shared data on PUSCH. Embodiments also contemplate that control signaling may be sent using the Physical Uplink Control Channel (PUCCH), that may include separating the control signaling from the uplink shared data transmitted on PUSCH. Embodiments contemplate systems and methods for the use of PUSCH by the User Equipment (UE) in, by way of example and not limitation, LTE Release 10 (LTE Advanced) systems to transmit Uplink Control Information (UCI) on PUSCH.

By way of example, UCI may include ACK/NAK, Channel Quality Indication (CQI), Precoding Matrix Indicator (PMI), and Rank Indication (RI) data, among other parameters or values. UCI may also include or indicate Scheduling Requests (SR). While the embodiments presented herein are mainly described in relation to the transmission of ACK/NAK and CQI feedback transmission from a UE to a NodeB (or an evolved Node B or eNodeB), such embodiments may also, or instead, be used to report other types of UCI and uplink signaling. Note also that while the embodiments described herein are mainly described in use with the frequency division duplexing (FDD) mode of E-UTRA operation, such embodiments may also be used with the time division duplexing (TDD) or half duplex FDD modes of operation.

In LTE R8/9, multiplexing of UCI and Uplink Shared Data (USD) may be supported using aperiodic reporting procedures. For example the CQI, PMI, or RI statuses are reported aperiodically using PUSCH upon receiving a Downlink Control Information (DCI) format 0 or a Random Access Response Grant, provided that the respective CQI request field is set to 1 and not reserved. The type of reporting mode used by the UE to provide the CQI/PMI, as well as the corresponding RI, is configured by higher layers. Similarly, the UCI and USD may include information related to an SR in the same or different subframe. Transmitting UCI using multiplexing may require the use of transmission resources for the PUSCH. UCI may be multiplexed together with data prior to DFT spreading. In LTE R8, PUCCH may not be transmitted at the same time as PUSCH. In LTE R8/9, one spatial layer may be supported for uplink transmissions.

In LTE R8/9, transmission resources may be determined using an offset parameter, β_{offset}^{PUSCH}PUSCHε{ACK/NAK,CQI,RI}, which may be applied to establish different coding rates for control information such as ACK/NACK, CQI and/or PMI, Rank Indication (RI), or other channel quality information. The coding rates for the control information may be determined by allocating a varying number of coded symbols, Q′, for transmission. Q′ may be determined by the following formula:

$${Q}^{′} = min ( ⌈ \frac{O \cdot {M}_{sc}^{PUSCH \text{-} initial} \cdot {N}_{symb}^{PUSCH \text{-} initial} \cdot {β}_{offset}^{PUSCH}}{{\sum }_{r = 0}^{C - 1} {K}_{r}} ⌉ , 4 \cdot {M}_{sc}^{PUSCH} ) \qquad ( 1 )$$

where O may be the number of Hybrid Automatic-Repeat-Request (HARQ)-ACK bits or rank indicator bits, M_{sc}^{PUSCH} may be the scheduled bandwidth for PUSCH transmission in the current sub-frame for the transport block, expressed as a number of subcarriers, and N_{symb}^{PUSCH-initial} may be the number of SC-FDMA symbols per subframe for initial PUSCH transmission for the same transport block given by N_{symb}^{PUSCH-initial}=(2·(N_{symb}^{UL}−1)−N_{SRS}). In TDD, HARQ-ACK bundling and HARQ-ACK multiplexing are supported. The HARQ-ACK may be one or two bits in bundling mode and between one and four bits in multiplexing mode. N_{symb}^{UL} may be the number of SC-FDMA symbols in an uplink slot. N_{SRS} may be equal to 1 if a UE is configured to send PUSCH and Sounding Reference Signal (SRS) in the same subframe for initial transmission or if the PUSCH resource allocation for initial transmission even partially overlaps with the cell-specific SRS subframe and bandwidth configuration. The cell-specific SRS subframe configuration period T_{SFC} and the cell-specific SRS subframe offset Δ_{SFC} may depend on the frame structure type and configuration parameters provided by higher layers in the form of an SRS subframe configuration parameter. Alternatively, N_{SRS} may be equal to 0. M_{sc}^{PUSCH-initial}, C, and Kᵣ may be obtained from the initial PDCCH for the same transport block or the most recent semi-persistent scheduling assignment PDCCH or the random access response grant for the same transport block, for example.

CQI/PMI resources may be placed at the beginning of the USD resources and may be mapped sequentially on one sub-carrier before continuing to the next. USD may be rate matched around the CQI/PMI data. ACK/NAK resources may be mapped to SC-FDMA symbols by puncturing USD. ACK/NAK symbol positions may be next to Reference Symbols (RS) to improve the decoding performance by leveraging the benefit of improved channel estimation. ACK/NAK resources may be configured to use, by way of example and not limitation, 4 SC-FDMA symbols.

Using the FDD E-UTRA mode ACK/NAK may support 1 or 2 bits, for example. The Modulation and Coding Scheme (MCS) used for UCI may be the same as that used for USD except that, for example, ACK/NAK may use QPSK (in an alternate embodiment perhaps exclusively) on the Resource Elements (RE) in which it may be punctured.

Repetition coding may be used for the channel coding of ACK/NAK. For example, if only 1 bit is used for ACK/NAK a simple repetition coding may be used, and if 2 bits are used for ACK/NAK a (3,2) simplex code may be used. The HARQ index value, I_{offset}^{HARQ-ACK}, may be determined by higher layer processing and can be mapped to a corresponding HARQ-ACK offset values for use in determining the number of coded bits. In one embodiment, the HARQ-ACK index value may be determined according to Table 8.6.3-1 as set forth in “3GPP TS 36.213 v9.0.1: Evolved Universal Terrestrial Radio Access (E-UTRA); Physical layer procedures” at section 8.6.3. This is included as Table 1, below:

TABLE 1
Exemplary Mapping of HARQ-ACK offset values and the index
signalled by higher layers (from 3GPP 36.213 v9.0.1)

| I_{offset}^{HARQ-ACK} | β_{offset}^{HARQ-ACK} |
|---|---|
| 0 | 2.000 |
| 1 | 2.500 |
| 2 | 3.125 |
| 3 | 4.000 |
| 4 | 5.000 |
| 5 | 6.250 |
| 6 | 8.000 |
| 7 | 10.000 |
| 8 | 12.625 |
| 9 | 15.875 |
| 10 | 20.000 |
| 11 | 31.000 |
| 12 | 50.000 |
| 13 | 80.000 |
| 14 | 126.000 |
| 15 | reserved |

where the index I_{offset}^{HARQ-ACK} may be signaled by higher layers as an Information Element, offset through the UE specific PUSCH configuration. In an exemplary embodiment, the HARQ-ACK offset index value, I_{offset}^{HARQ-ACK}, the RI offset index value, I_{offset}^{RI}, and the CQI offset index value, I_{offset}^{CQI}, may be sent as an Information Element Array, such as in “PUSCH-Config”, as shown below:

| | |
|---|---|
| PUSCH-ConfigDedicated ::= | SEQUENCE { |

| | |
|---|---|
| betaOffset-ACK-Index | INTEGER (0..15), |
| betaOffset-RI-Index | INTEGER (0..15), |
| betaOffset-CQI-Index | INTEGER (0..15) |

}

When UCI is sent on PUSCH without the presence of USD, the number of coded symbols Q′ may be determined, by the following formula:

$${Q}^{′} = min ( ⌈ \frac{O \cdot {M}_{sc}^{PUSCH} \cdot {N}_{symb}^{PUSCH} \cdot {β}_{offset}^{PUSCH}}{{O}_{CQI - MIN}} ⌉ , 4 \cdot {M}_{sc}^{PUSCH} ) \qquad ( 2 )$$

where for HARQ-ACK information Q_{ACK}=Qₘ·Q′ and [β_{offset}^{PUSCH}=β_{offset}^{HARQ-ACK}/β_{offset}^{CQI}], where Qₘ may be the modulation order. O_{CQI-MIN} may be the number of CQI bits including CRC bits assuming rank equals to 1, and N_{symb}^{PUSCH} may be the number of SC-FDMA symbols in the current PUSCH transmission sub-frame given by N_{symb}^{PUSCH}=(2·(N_{symb}^{UL}−1)−N_{SRS}) where N_{SRS} and N_{symb}^{UL} were described above. The modulation order may be determined by reading the modulation and coding scheme and redundancy version field (I_{MCS}), and checking the CQI request bit. The modulation order may also depend on the UE capability of supporting 64QAM in PUSCH, and/or whether higher layers may have configured the UE to transmit only in QPSK and 16QAM, for example. In other instances the modulation order may be mapped directly from the determined I_{MCS}. Alternatively, embodiments contemplate that the value of the determined I_{MCS}, the logical value of the CQI request bit and the DCI value transported in the latest PDCCH with DCI format 0 for the same transport block may be used to determine an appropriate modulation order. β_{offset}^{HARQ-ACK} may be determined based on the corresponding HARQ-ACK offset index sent from higher layers.

LTE-Advanced (LTE R10) is an evolution that may improve LTE R8/9's data rates using, among other methods, bandwidth extensions also referred to as Carrier Aggregation (CA). With CA, the UE may transmit and receive simultaneously over the PUSCH and the Physical Downlink Shared Channel (PDSCH) of multiple Component Carriers (CCs). Embodiments contemplate that, by way of example and not limitation, up to five CCs in the UL and in the DL may be used, thus supporting flexible bandwidth assignments up to 100 MHz.

The control information for the scheduling of PDSCH and PUSCH may be sent on one or more PDCCH(s). In addition to the LTE R8/9 scheduling that may use one PDCCH for a pair of UL and DL carriers, cross-carrier scheduling may also be supported for a given PDCCH, allowing a network to provide PDSCH assignments and/or PUSCH grants for transmissions in other CC(s).

Embodiments contemplate support for different types of CCs may be included in LTE-A. When referred to hereafter, the term “primary component carrier” (PCC) includes, by way of example and without loss of generality, a carrier of a UE configured to operate with multiple component carriers for which some functionality, such as derivation of security parameters and NAS information, may be applicable to that component carrier (in an alternative embodiment perhaps exclusively to that component carrier). The UE may be configured with at least one PCC for the downlink (DL PCC) and at least one PCC for the uplink (UL PCC). Consequently, a carrier which is not a PCC of the HE is hereafter referred to as, by way of example and not limitation, a Secondary Component Carrier (SCC).

For example, a DL PCC may correspond to the CC used by the UE to derive initial security parameters when initially accessing the system. In another example, the UL PCC may correspond to the CC whose PUCCH resources are configured to carry some or all Uplink Control Information (UCI) (e.g., HARQ ACK/NACK and Channel State Information (CSI) feedback for a given UE).

For LTE R10, with carrier aggregation, when a UE is configured with at least one UL SCC having at least one PUSCH allocation for a transmission in a subframe in which it may be expected to transmit UCI information (e.g., up to 10 ACK/NACK bits), the maximum number of available UCI bits of R8/9 (i.e., 2 bits) may be no longer suitable.

For LTE R10 FDD, when spatial bundling may be used (i.e., when the UE can receive more than one codeword (hereafter CW) in a given DL CC in the same subframe), assuming an efficient coding method that may take DTX into account, as many as 10 bits (5 DL CCs with 2 TB per CC each, for example) may be needed for transmission of HARQ ACK/NACK feedback. Moreover, in many scenarios, 3 bits (2 DL CCs) or 5 bits (3 DL CCs) per PUSCH transmission in FDD may be needed, for example. Given these factors, and considering the LTE-A FDD design, the embodiments described herein may provide for a number of UCI bits to be transmitted on PUSCH. In addition, embodiments described herein may provide for uplink transmissions that use spatial multiplexing where UCI information (e.g., ACK/NACKs for multiple DL carriers with either one, two, or more codewords) may be transmitted over multiple spatial layers.

Embodiments contemplate that LTE-A systems may not support simultaneous ACK/NACK on PUCCH transmission from a single UE on multiple UL CCs, for example. Also by way of example and not limitation, embodiments also contemplate that a single UE-specific UL CC may be configured semi-statically for carrying PUCCH ACK/NACK.

Transmission of UCI information (e.g., HARQ ACK/NACK feedback for multiple DL CCs) may be desirable in LTE R10 systems. Capabilities to support multiplexing of UCI and USD may also be desirable for LTE R10. Embodiments contemplate that more than a maximum of 2 bits, which may be a maximum for LTE R8, may be supported, while maintaining coverage (e.g., minimum signal-to-interference noise ratio (SINR)) for UCI transmission (e.g., ACK/NACK) on PUSCH. Embodiments contemplate UCI bits for HARQ ACK/NACK feedback, as well as other types of UCI (e.g., CQI, PMI and RI.).

Embodiments contemplate modifications to formulas (1) and (2), discussed previously, for the number of coded symbols Q′ that may accommodate a larger number of ACK/NAK bits that may be used for the multiplexing of UCI and Uplink Shared Data on PUSCH. In the presence of UL data, in order to derive the upper bound on the number of coded symbols Q′ for HARQ-ACK, formula (1) may be evaluated for a small or perhaps smallest possible transport block size, for example. In an embodiment, β_{offset}^{HARQ-ACK} range may vary, by way of example and not limitation, from 2 to 126. The smallest possible transport block size may be 40 bits, for example, which may be associated with one RB of UL allocation (i.e., 16 bits data plus 24 parity bits comprising CRC). Therefore, the upper bound on Q′ may be given by, for example:

$$Λ = min ( ⌈ \frac{O \cdot 12 \cdot 12 \cdot {β}_{offset}^{HARQ \text{-} ACK}}{40} ⌉ , 4 {M}_{sc}^{PUSCH} ) = 8 to 48 \qquad ( 3 )$$

for β_{offset}^{HARQ-ACK}ε{2, . . . , 126} and Oε{1, . . . , 10}. Embodiments contemplate that the largest possible number of ACK/NACK bits (i.e., O=10) may be derived assuming spatial multiplexing within a CC.

Embodiments contemplate performance targets that may be required for NACK transmission on PUSCH. Embodiments contemplate that the eNodeB may make sure that sufficient RBs are assigned in the UL grant to the UE. For example, in the case where M_{sc}^{PUSCH} is greater than 12, it may be implied that there is more than one RB assigned to the UE for UL transmission on PUSCH. A lower bound on Q′, by assuming the largest possible transport block size, may depend on whether or not spatial multiplexing is employed in the uplink.

In embodiments that may employ dual layer with spatial multiplexing in the UL, the range of Q′ may be given by:

$${Q}^{′} = ⌈ \frac{O \cdot 2 \cdot 110 \cdot 12 \cdot 12 \cdot {β}_{offset}^{HARQ \text{-} ACK}}{149776} ⌉ = 1 to 217 \qquad ( 4 )$$

for β_{offset}^{HARQ-ACK}ε{2, . . . , 126} and Oε{1, . . . , 8} or of {1, . . . , 10}.

In embodiments that may employ a single layer with no spatial multiplexing in the UL, the range of Q′ may be given by:

$${Q}^{′} = ⌈ \frac{O \cdot 110 \cdot 12 \cdot 12 \cdot {β}_{offset}^{HARQ \text{-} ACK}}{75376} ⌉ = 1 to 212 \qquad ( 5 )$$

for β_{offset}^{HARQ-ACK}ε{2, . . . , 126} and Oε{1, . . . , 8} or of {1, . . . , 10}.

As can be seen, for large transport block (TB) sizes, by using a larger β_{offset}^{HARQ-ACK}, a sufficient number of coded symbols may be reserved for signaling ACK/NACK information bits on PUSCH.

Given the above overview of formula (1) it may be recognized that the maximum value of β_{offset}^{HARQ-ACK} defined in LTE R8, may be increased to accommodate an ACK/NAK payload of greater than 2 bits, for example.

In LTE R8/9, the energy per ACK/NACK information bit may be maintained approximately constant by scaling the number (or fraction) of symbols used for the transmission of ACK/NACK within the resources allocated for PUSCH transmission. The maximum number of symbols that can be used for ACK/NACK transmission may be 4 times the number of sub-carriers in the PUSCH allocation. This may represent up to (4/14) of the power of the PUSCH in case of 7 symbols per slot, for example. More generally, if the number of UCI bits, such as ACK/NACK and CQI/PMI/RI bits, is increased for multi-carrier transmission in the DL, it may be possible that the energy per UCI may become insufficient, even with (4/14) of the power of the PUSCH for ACK/NACK bits. Also, if there should be a large number of UCI bits, such as CQI bits, it may be possible that the energy for the data may become insufficient. Embodiments contemplate that these potential insufficiencies may be overcome.

In LTE R8/9, when HARQ ACK/NACK bits or RI may consist of one or two information bits, the modulation of the encoded bits may be limited to Quadrature Phase Shift Keying (QPSK) even when the data codeword may utilize a different modulation scheme. However, for large payload sizes (i.e., more than two bits of UCI information, for example), the Reed-Muller (RM) encoded bits may follow the same modulation scheme as the one applied to the data/CQI. Given that in Rel-10 and beyond, due to carrier aggregation, the payload sizes for HARQ ACK/NACK and RI may be up to 11 bits (or even up to 15 bits in the case of RI), the application of a higher order modulation scheme such as 16 QAM and 64 QAM for transmission of UCI information may result in performance loss with respect to QPSK. Noting that the performance targets defined by the standard for UCI transmission on PUSCH may be different from those defined for data transmission, the adaptive modulation and coding (AMC) mechanism currently used for uplink data transmission may not be able to compensate for the performance loss due to higher modulation for HARQ ACK/NACK and RI. Embodiments contemplate capabilities that may overcome these deficiencies.

As mentioned previously, in LTE R8, a single spatial layer, for example a single antenna port transmission, may be supported for uplink transmissions. Typically, the basic structure of spatial multiplexing is such that one or two codewords (where one codeword corresponds to one transport block) may be mapped to multiple layers. One codeword may map to a minimum of one layer and to as many as the maximum number of antenna ports.

For LTE R10, when the UE may use spatial multiplexing in the uplink, embodiments contemplate that formula (1) (that may derive the number of coded symbols V) may be modified to account for more than one spatial layer. The number of spatial layers may be represented by Nₛₘ which for LTE-A may typically be 1 or 2 layers, for example, but no implication of a maximum number of possible layers should be construed from this disclosure. Using this representation, Formula (1), may be modified as follows:

$${Q}^{′} = min ( ⌈ \frac{O \cdot {N}_{sm} \cdot {M}_{sc}^{PUSCH \text{-} initial} \cdot {N}_{symb}^{PUSCH \text{-} initial} \cdot {β}_{offset}^{PUSCH}}{{\sum }_{r = 0}^{C - 1} {K}_{r}} ⌉ , 4 \cdot {M}_{sc}^{PUSCH} ) \qquad ( 6 )$$

The UE may use the formula (6) to determine the total number of UCI channel coded bits for the PUSCH transmission across one or all layers. Formula (6) may be applicable to the transmission of HARQ ACK/NACK bits or RI bits depending on their respective parameters to achieve some transmit diversity, for example.

Alternatively, the UCI bits for HARQ ACK/NACK and/or RI may be transmitted based on the transmission of a codeword. Using this representation the formula, Formula (1), above, may be modified as follows to describe the number of coded symbols as a function of the number of transport blocks:

$${Q}^{′} ( n ) = min ( ⌈ \frac{\frac{O}{B} \cdot {N}_{sm , n} \cdot {M}_{sc}^{PUSCH \text{-} initial} \cdot {N}_{symb}^{PUSCH \text{-} initial} \cdot {β}_{offset}^{PUSCH}}{{\sum }_{r = 0}^{{C}_{n} - 1} {K}_{r , n}} ⌉ , 4 \cdot {M}_{sc}^{PUSCH} ) \qquad ( 7 )$$

where:
N_{sm,n} may be the number of layers carrying the n^{th} TB (i.e. CW);
K_{r,n} may be the total number of bits for the r^{th} code block of the n^{th} TB in which HARQ ACK (or RI) is transmitted;
Cₙ may be the total number of code blocks for the n^{th} TB;
O may be the number of UCI bits (e.g., ACK/NACK, RI, etc.) to be transmitted in the n-th TB;
B may be the total number of TBs used to transmit HARQ-ACK. Alternatively, B may be set to 1 regardless of the actual number of TBs used to transmit HARQ ACK/NACK (or RI) bits.

When the UE transmits more than one codeword (i.e., more than one TB), some or all HARQ ACK/NACK bits and/or RI bits, or a portion thereof, may be transmitted together using a single codeword, in which case B may be equal to 1, for example. Otherwise, if HARQ ACK/NACK bits (or RI) are distributed equally between each codeword with different bits transmitted by each codeword, the number of UCI bits “O” may be divided by B=the number of codewords. For example, if two codewords are used, B may be equal to 2 in the equation above, for example. If the HARQ ACK/NACK bits (or the RI) are transmitted using some or all the codewords in a given subframe, with the same bits in all the codewords (e.g., HARQ ACK/NACK or RI bits replicated over all the layers of all the codewords), then B may be equal to 1 in the above equation.

Alternatively, embodiments contemplate an LTE R10 UE may be configured with spatial multiplexing for uplink transmissions that may replicate UCI by transmitting UCI for HARQ ACK/NACK and/or RI, or a portion thereof, such that the transmission of each codeword includes the same UCI information bits using the same number of channel coded bits, identically coded, for example, if some or all the codewords have the same MCS or different respective MCSs. Alternatively or additionally embodiments contemplate that the transmission of each codeword may use a different number of channel coded bits if, for example, the different codewords have different respective MCSs.

Embodiments contemplate that for improved UCI performance, the number of UCI symbols may be selected as Q′=max (Q′ (1), Q′ (2)), where Q′(1), Q′(2) may be calculated using formula (7) with B=1, for example. Alternatively, to minimize the impact of the UCI bits on the data throughput, the number of UCI symbols may be selected as Q′=min(Q′(1),(Q′(2)). In another alternative, the number of UCI symbols may be selected as Q′(1) for codeword #1 (CW1) and Q′(2) for codeword #2 (CW2), for example. In yet another alternative, Equation 6 and/or Equation 7 may be evaluated per spatial layer for at least one codeword, in the case of many-to-one mapping between layers and codewords.

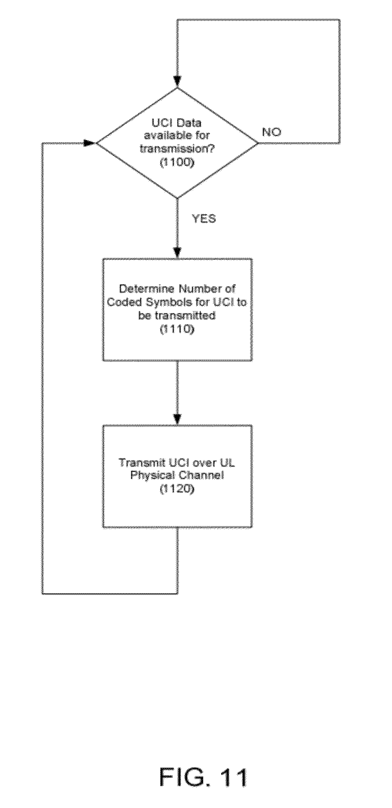

FIG. 11 illustrates an exemplary method for transmitting UCI over a physical channel by a WRTU. At 1100, it may be determined whether there is UCI data available for transmission. If there is UCI data available for transmission, at 1110 a number of coded symbols for UCI data may be determined. The determination can be performed, by one of the methods disclosed herein, based on the offset parameter, the number of codewords to be transmitted, the size of the UCI, the type of UCI message, the modulation scheme of the message, signals sent from higher levels and/or physical layer, and/or other characteristics of the physical channel, for example. Additionally, embodiments contemplate determining the number of coded symbols can take into account the number of active component carriers or the number of configured component carriers, or spatial layers available for transmission. At 1120, the UCI data can be transmitted over the coded channel.

Alternatively, in embodiments based on Formula 6 or Formula 7, an LTE R10 UE configured with spatial multiplexing for uplink transmissions may distribute UCI by transmitting UCI for HARQ ACK/NACK and/or RI, or a portion thereof, such that the transmission of each codeword may include an equal fraction of the UCI information bits or an equal number of channel coded bits or a same set of channel coded UCI bits.

In an alternate embodiment, the UCI bits (e.g., ACK/NACK and/or RI and/or CQI/PMI) to be transmitted may be distributed between the codewords based on at least one of:

the SINR per codeword

the CQI level per codeword

the coding rate per codeword

the number of coded bits per codeword

the number of information bits per codeword

the number of configured DL CCs

As an example for a case of two codewords, the ratio between the number of UCI bits transmitted on CW1 and CW2 may be set to the square root of the ratio of SINR of CW1 and CW2, respectively. Alternatively, the number of UCI bits on each codeword may be set so that the ratio between the effective coding rates of CW1 and CW2 after taking into account the effect of puncturing by UCI bits, may be the same as the ratio between the coding rates of CW1 and CW2 before puncturing by UCI bits (or equivalently, the ratio between the number of coded bits between CW1 and CW2 may not be affected by the puncturing of UCI bits.) Such distribution may be achieved by setting the ratio of UCI bits between codewords equal to the ratio of number of coded bits between codewords. Alternatively, this could be combined with the above method, in case of many-to-one mapping between layers and codewords.

Embodiments contemplate that UCI may be transmitted on PUSCH with or without USD. For LTE R8, a single spatial layer and codeword is supported for uplink transmissions. For LTE R10, when the UE uses spatial multiplexing in the uplink, for UCI on PUSCH without USD, formula (2) (for deriving the number of coded symbols Q′) may be modified to account for more than one spatial layer. Using the representation for Nₛₘ provided above, Formula (6) may be modified as follows:

$${Q}^{′} = min ( ⌈ \frac{O \cdot {N}_{sm} \cdot {M}_{sc}^{PUSCH} \cdot {N}_{symb}^{PUSCH} \cdot {β}_{offset}^{PUSCH}}{{O}_{CQI - MIN}} ⌉ , 4 \cdot {M}_{sc}^{PUSCH} ) \qquad ( 8 )$$

Similarly as for the case where data may be multiplexed together with the UCI as described above, a UE may be configured to replicate the UCI channel coded bits (e.g., HARQ ACK/NACK bits or RI bits) on each spatial layer, and/or distribute the UCI information over multiple spatial layers.

Embodiments contemplate that UCI may be multiplexed with USD on PUSCH. For example, UCI may be replicated on one or each codeword. For an LTE R10 UE configured with spatial multiplexing for uplink transmissions, the UE may multiplex data and control information for CQI and/or PMI by appending the same uplink control information to the USD (if any) for each TB, which may then be mapped to the corresponding codeword for transmission using one or multiple layers per codeword. Thus each codeword may contain the same number of UCI bits for CQI and/or PMI, or combination thereof, containing the same uplink control information.

Alternatively, UCI may be distributed over multiple codewords. An LTE R10 UE configured with spatial multiplexing for uplink transmissions may multiplex data and control information for CQI and/or PMI by appending a fraction of the uplink control information to the USD (if any) for each TB, which may then be mapped to the corresponding codeword for transmission using one or multiple layers per codeword. Thus each codeword may contain the same number of UCI bits for CQI and/or PMI, each containing a subset of the uplink control information, for example.

Embodiments contemplate that UCI and USD may be mapped on PUSCH and UCI may be mapped to a single codeword. When the UCI (CQI/PMI) may be mapped to a single codeword (e.g., CWn, where n is either 1 or 2), the number of symbols to be used for CQI/PMI mapped on PUSCH may be calculated taking into account one or more of the following parameters:

The number of layers N_{sm,n} of codeword n

The coding rate of codeword n

The number of transmission codewords for the corresponding serving CC

The number of symbols used for the RI

The number of configured DL CCs

For example, a variation of Formula (7) may be used to determine the number of CQI/PMI coded symbols for transmission as expressed as a function of the number of transport blocks, which can be shown to be:

$${Q}^{′} ( n ) = min ( \begin{matrix}⌈ \frac{( O + {L}_{CRC} ) \cdot {M}_{sc}^{PUSCH - initial} \cdot {N}_{symb}^{PUSCH - initial} \cdot {β}_{offset}^{PUSCH} \cdot {N}_{sm , n}}{{\sum }_{r = 0}^{{C}_{n} - 1} {K}_{r , n}} ⌉ , \\ {M}_{sc}^{PUSCH} \cdot {N}_{symb}^{PUSCH} - \frac{{N}_{sm , n} * {Q}_{RI , n}}{{Q}_{m}}\end{matrix} ) \qquad ( 9 )$$

where L_{CRC} may be the number of CRC bits given by

$${L}_{CRC} = \{ \begin{matrix}0 & O \leq 11 \\ 8 & otherwise ,\end{matrix}$$

and Q_{RI,n} may be the number of UCI RI symbols on CWn. If RI is not transmitted then Q_{RI,n}=0, for example. N_{sm,n} may be the number of layers carrying the n^{th} codeword (i.e. CWn). Alternatively, N_{sm,n} may be set to 1 regardless of the actual number of layers for CWn.

In other embodiments, the LTE R8 addressable offset range (i.e., β_{offset}^{HARQ-ACK}) may be extended. Embodiments contemplate modifying the mapping of HARQ ACK/NACK offset values. In an embodiment, offset values may be offset by using a higher offset β_{offset}^{HARQ-ACK} value. Taking into consideration that the HARQ index value, which may be determined by higher layer processing, can be mapped to a corresponding HARQ-ACK offset values for use in determining the number of coded bits, the offset values can be scaled in order to achieve a larger range of offset values, as was described in Table 1. The reserved entry I_{offset}^{HARQ-ACK}=15, for example, may be used to extend the range of β_{offset}^{HARQ-ACK} to a larger number (e.g., 200) to provide a larger range for β_{offset}^{HARQ-ACK}. A representative example is shown in Table 2 below:

TABLE 2
Exemplary Mapping of HARQ-ACK Offset Values and the Index
Signaled By Higher Layers with a Modified Reserved Value

| I_{offset}^{HARQ-ACK} | β_{offset}^{HARQ-ACK} |
|---|---|
| 0 | 2.000 |
| 1 | 2.500 |
| 2 | 3.125 |
| 3 | 4.000 |
| 4 | 5.000 |
| 5 | 6.250 |
| 6 | 8.000 |
| 7 | 10.000 |
| 8 | 12.625 |
| 9 | 15.875 |
| 10 | 20.000 |
| 11 | 31.000 |
| 12 | 50.000 |
| 13 | 80.000 |
| 14 | 126.000 |
| 15 | 200.000 |

In other embodiments where the LTE R8 addressable offset range (i.e., β_{offset}^{HARQ-ACK}) may be extended, alternative β_{offset}^{HARQ-ACK} offset values may be used. Instead of the modifications represented in Table 2, a new table may be defined for β_{offset}^{HARQ-ACK} in Rel-10 to extend the range of β_{offset}^{HARQ-ACK} (i.e., remapping to alternative values). For example, the representative example in Table 3 may accommodate β_{offset}^{HARQ-ACK} values up to 820, for example. Embodiments contemplate that the UE may use a semi-static procedure to use either Table 2 or Table 3 below depending on the mode of operation.

TABLE 3
Exemplary mapping of HARQ-ACK Offset Values and the Index Signaled
by Higher Layers Scaled to Incorporate Larger Offset Values

| I_{offset}^{HARQ-ACK} | β_{offset}^{HARQ-ACK} |
|---|---|
| 0 | 4.000 |
| 1 | 5.000 |
| 2 | 6.250 |
| 3 | 8.000 |
| 4 | 10.000 |
| 5 | 12.625 |
| 6 | 15.875 |
| 7 | 20.000 |
| 8 | 31.000 |
| 9 | 50.000 |
| 10 | 80.000 |
| 11 | 126.000 |
| 12 | 200.000 |
| 13 | 320.000 |
| 14 | 512.000 |
| 15 | 820.000 |

Embodiments contemplate that a mode of operation employed may be a function of at least one of the following parameters: 1) The number of configured DL CCs at subframe n; 2) The number of codewords the UE can receive in each DL CC in subframe n, e.g., whether or not spatial multiplexing is used (if so, e.g., based on the transmission mode); 3) The number of activated DL CCs at subframe n; in an embodiment, perhaps counting only explicitly activated CCs; 4) Possibly a value or an indication received upon activation of a DL CC, using at least one of: L1/PDCCH, L2/MAC (e.g., in a MAC control element); and/or L3/RRC signaling; 5) The number of successfully decoded PDSCH in subframe n; in an embodiment, perhaps also including a configured DL assignment (i.e., SPS); 6) The number of DL CCs in DRX active time (e.g., in case of CC-specific DRX behavior); and/or 7) An explicitly signaled value (e.g., similar to DAI) corresponding to the number PDSCH assignment at subframe n. In an embodiment, PUSCH transmission in subframe n+4 is signaled in the DCI format for the UL grant on PDCCH at subframe n, signaled in the DCI format for a PUSCH assignment on PDCCH at subframe n, and/or signaled as part of a cross-CC assignment.

Embodiments contemplate that, where the LTE R8 addressable offset range (i.e., β_{offset}^{HARQ-ACK}) may be extended, β_{offset}^{HARQ-ACK} may be scaled. The entries in Table 1 may be implicitly scaled to extend the range of β_{offset}^{HARQ-ACK} (i.e., remapping to new values) using one or more scaling factors. A UE may derive at least one scaling factor based on at least one of the parameters listed in the previous paragraph, for example, to determine a mode of operation. In effect, this may provide a configuration with multiple mapping tables, where a table may be selected for use for a given value of the index I_{offset}^{HARQ-ACK}.

Embodiments contemplate, where the LTE R8 addressable offset range (i.e., β_{offset}^{HARQ-ACK}) may be extended, a list of I_{offset}^{HARQ-ACK} offsets may be indexed. In such an embodiment, a UE may determine the index I_{offset}^{HARQ-ACK} to derive the offset β_{offset}^{HARQ-ACK} for UCI transmission on PUSCH by selecting an item from one or more lists of configured values (e.g., using RRC), for example, based on transmission mode configured for PUSCH, where the selected item may be derived from at least one of the parameters described previously to determine a mode of operation. In effect, this may provide for dynamic derivation of the value of the index I_{offset}^{HARQ-ACK} within a finite set of values, for example.

Embodiments contemplate, where the LTE R8 addressable offset range (i.e., β_{offset}^{HARQ-ACK}) may be extended, a 2-D lookup table may be used for β_{offset}^{HARQ-ACK}. The β_{offset}^{HARQ-ACK} factor may be a function of the multi-antenna transmission scheme (e.g., transmit diversity, spatial multiplexing), including the number of codewords and number of layers used for the transmission. To account for such a potential dependency, embodiments contemplate using a 2-D table for Rel-10, among other releases, for example. One or more columns of such a 2-D lookup table, an exemplary and non-limiting example of which is illustrated below as Table 4, represents the β_{offset}^{HARQ-ACK} values that may be used for a given transmission scheme and number of CWs and/or layers. This may require, by way of example and not limitation, the signaling of a single 4-bit I_{offset}^{HARQ-ACK} index for ACK/NACK. A single index may provide a set of β_{offset}^{HARQ-ACK} values, one for each transmission scheme and CW/layer configuration. Embodiments like these may be used for scenarios where the same β_{offset}^{HARQ-ACK} value may be applied for both codewords, and may be extended for scenarios where a codeword specific β_{offset}^{HARQ-ACK} value may be employed. An example of a 2-D lookup table for the case of up to two codewords and up to four layer transmission is shown in Table 4.

TABLE 4
Exemplary 2-D Lookup Table for β_{offset}^{HARQ-ACK}

| | β_{offset}^{HARQ-ACK} | β_{offset}^{HARQ-ACK} | β_{offset}^{HARQ-ACK} | β_{offset}^{HARQ-ACK} | β_{offset}^{HARQ-ACK} |
|---|---|---|---|---|---|
| | 1 CW/1 layer | 1 CW/2 | 2 CW/2 | 2 CW/3 | 2 CW/4 |
| I_{offset}^{HARQ-ACK} | (Rel-8/9) | layers | layers | layers | layers |
| 0 | 2.000 | β_{12.0} | β_{22,0} | β_{23,0} | β_{24,0} |
| 1 | 2.500 | β_{12.1} | β_{22,1} | β_{23,1} | β_{24,1} |
| . . . | . . . | . . . | . . . | . . . | . . . |
| 15 | reserved | | | | |

In embodiments, fallback to single antenna port transmission may be employed. When a UE is configured for UL multi-antenna transmission mode, an eNodeB may send a UL grant for a single antenna port transmission scheme. In this case, the UE may fall back to single antenna port transmission for the corresponding UL PUSCH transmission. An advantage of using the lookup may be that few or no additional signaling to determine β_{offset}^{HARQ-ACK} may be needed. More specifically, using the configured I_{offset}^{HARQ-ACK} index, the UE may determine the β_{offset}^{HARQ-ACK} for the 1 CW and 1 layer scheme, or alternatively for the 1 CW and 2 layers scheme, from a 2-D lookup table, such as Table 4, for example.

Embodiments also contemplate, where the LTE R8 addressable offset range (i.e., β_{offset}^{HARQ-ACK}) may be extended, a transmission scheme (or transmission mode) specific I_{offset}^{HARQ-ACK} may be signaled. In embodiments, the β_{offset}^{HARQ-ACK} values may be defined in a single column (or with a single Table like Table 1, 2 or 3 or the tables defined in 36.213), and the index (e.g., I_{offset}^{HARQ-ACK}) may be signaled for each UL transmission scheme (CW/layer configuration). The size of the column may be increased from that of the Rel-8/9 size to accommodate the potentially different values of beta for the different transmission schemes and CW/layer configurations. Alternatively, the existing Rel-8/9 table(s) associated with β_{offset} may be reused rather than increasing the size of the Rel-8/9. The index thus signaled may need a larger field (compared to the 4-bit index used in Rel-8/9, for example). Alternately, the I_{offset}^{HARQ-ACK} index may be signaled for the 1 CW and 1 layer scheme, while for any other scheme (multiple codeword multiple layer) a delta value of the index with respect to the 1 CW and 1 layer transmission may be signaled.

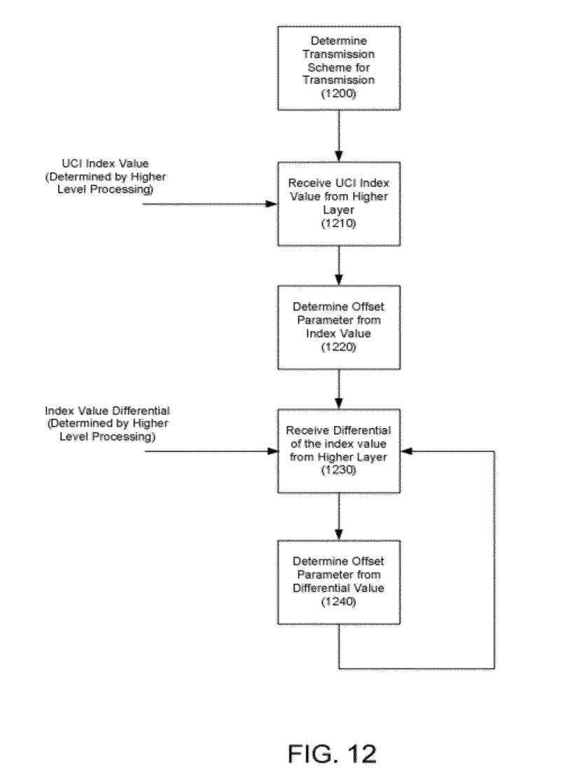

FIG. 12 illustrates an exemplary method that may determine an offset value based on a differential index value that may be signaled by higher layers. At 1200, the initial transmission scheme may be determined. At 1210, an index value can be received from higher level processing that may correspond to an appropriate offset value. In an embodiment, the index value can be used to determine the offset parameter at 1220. For subsequent transmissions, the higher level can then signal a differential or delta value of the previously received index with respect to the transmission scheme and/or the previous index value at 1230. The appropriate offset value can be determined based on the differential value at 1240. The method described in FIG. 12 could be applied, for example, to a system containing one or more component carriers. In one embodiment, the differential value could be applied to the previous index value with respect to the previously reported number of available component carriers, the previously reported index value, or both. The offset value could correspond to the offset value of the various UCI components, such as HARQ ACK/NACK, PMI, CQI, RI, and/or SR.

Alternatively, the mapping of RI offset values may be modified. Embodiments contemplate that a higher β_{offset}^{RI} offset value may be used. The maximum value of β_{offset}^{RI} for feedback of RI values may be obtained by modifying Table 1 in a similar manner as that done for β_{offset}^{HARQ-ACK} set forth above in regard to Table 2.

In other embodiments where the mapping of RI offset values may be modified, alternative β_{offset}^{RI} offset values may be used. In this embodiment, the maximum value of β_{offset}^{RI} for feedback of RI values may be obtained modifying Table 1 in a similar manner as that done for β_{offset}^{HARQ-ACK} set forth above in regard to Table 3. Note that these two embodiments are not the only possible representation of the mapping table for β_{offset}. Any modification of the mapping table of Table 1 that increases the maximum value of β_{offset} may be used, and all such embodiments are contemplated as within the scope of the present disclosure.

Alternatively, where the mapping of RI offset values may be modified, β_{offset}^{RI} offset values may be scaled. In this embodiment, the entries in Table 1 may be implicitly scaled to extend the range of β_{offset}^{RI} (i.e., remapping to alternative values) using a scaling factor. The UE may derive the scaling factor based on at least one of the parameters described previously used to determine a mode of operation. In effect, this provides a configuration with multiple mapping tables that allows for the selection of a table to use for a given value of the index I_{offset}^{RI}.

Alternatively, embodiments contemplate, where the mapping of RI offset values may be modified, the index I_{offset}^{RI} may be determined by a UE and used to derive the offset β_{offset}^{RI} for UCI transmission on PUSCH by selecting an item from a list of configured values (e.g., using RRC), for example, based on transmission mode configured for PUSCH, where the item may be derived from at least one of the parameters described previously used to determine a mode of operation. This may provide for dynamic derivation of the value of the index within a finite set of values.

Alternatively, embodiments contemplate, where the mapping of RI offset values may be modified, a 2-D lookup table may be used for β_{offset}^{RI}. To account for the fact that β_{offset}^{RI} may be a function of a multi-antenna transmission scheme and a CW/layer configuration, embodiments contemplate a 2-D lookup table may be used for β_{offset}^{RI}, similar to the one proposed for above in the disclosure using exemplary Table 4.

Alternatively, embodiments contemplate, where the mapping of RI offset values may be modified, a transmission scheme specific I_{offset}^{RI} may be signaled. Embodiments contemplate that the β_{offset}^{RI} values may be defined in a single column, and the index I_{offset}^{RI} may be signaled for each UL transmission scheme (CW/layer configuration), similar to signaling of I_{offset}^{HARQ-ACK} as described previously.

Alternatively, embodiments contemplate that I_{offset}^{RI} and/or I_{offset}^{HARQ-ACK} range may be modified in PUSCH-Config (Dedicated). LTE R8 may provide the information elements (IEs) for the definition of β_{offset}. An extension or a new IE applicable only for UEs supporting multicarrier operation may be defined in some embodiment, which extends the range of indexes for I_{offset}^{HARQ-ACK}, I_{offset}^{RI}, and I_{offset}^{CQI} as shown below:

PUSCH-Config information element

| | |
|---|---|
| PUSCH-ConfigDedicatedR10 ::= | SEQUENCE { |

| | |
|---|---|
| betaOffset-ACK-Index | INTEGER (0..31), |
| betaOffset-RI-Index | INTEGER (0..31), |
| betaOffset-CQI-Index | INTEGER (0..31) |

}

Using this IE, a table with 32 entries may be defined that supports an extension of the values for β_{offset}^{HARQ-ACK}, β_{offset}^{RI}, and β_{offset}^{CQI} respectively, to a value greater than the maximum 126.

In alternate embodiments, if a UE is expected to transmit UCI for CQI/PMI, RI, and ACK/NAK in the same PUSCH transmission (i.e., in the same subframe), the UE may prioritize the transmission of UCI for HARQ ACK/NACK and may drop CQI/PMI and/or RI report. This may be based on a configuration of the UE and/or whether the number of channel coded bits for HARQ ACK/NACK exceeds the range of applicable resource blocks (RBs), for example. Alternatively, this may be based on whether the corresponding beta value exceeds a predetermined or configured threshold. This embodiment may avoid puncturing of CQI/PMI and/or RI for that subframe to maintain the performance of CQI/PMI and/or RI feedback.

Embodiments contemplate that a UE may be configured to determine the number of UCI bits that it will need to transmit. The UE may determine the number of UCI bits to encode either semi-statically or dynamically, and then determine the number of channel coded bits for transmission of said UCI.

$${Q}^{′} = min ( ⌈ \frac{O \cdot {M}_{sc}^{PUSCH} \cdot {N}_{symb}^{PUSCH} \cdot {β}_{offset}^{PUSCH}}{{O}_{CQI - MIN}} ⌉ , 4 \cdot {M}_{sc}^{PUSCH} ) \qquad ( 10 )$$

The UE may derive the number of UCI bits (e.g., ACK/NACK bits, CQI/PMI, and/or RI bits) from at least one of the parameters described previously (where the mode of operation may be function of such parameters) and perhaps additionally as a function of the encoding method used for transmission of said UCI information bits (e.g., individual coding, joint coding, Reed-Muller coding, Huffman encoding or any other coding method used prior to the channel coding of said UCI information bits.) The choice of encoding method to apply to the UCI information bits may itself depend on the number of information bits to transmit, for example.

Embodiments contemplate that a UE may spread UCI across one or more, or multiple, PUSCH transmissions. Embodiments contemplate the following:

$${Q}^{′} = min ( ⌈ \frac{{O}^{″} \cdot ( {M}_{sc , {CC}_{j}}^{PUSCH - initial} \cdot {N}_{symb , {CC}_{j}}^{PUSCH - initial} ) \cdot {β}_{offset , {CC}_{j}}^{PUSCH}}{{\sum }_{r = 0}^{{C}_{CC} - 1} {K}_{r , {CC}_{j}}} ⌉ , 4 \cdot {M}_{sc , {CC}_{j}}^{PUSCH} ) \qquad ( 11 )$$

### Where:

CCⱼ may be the j-th UL CC on which UCI feedback is sent
O″ may be the number of ACK/NAK bits or the number of bits required to represent HARQ-ACK/NAK/DTX states for multiple activated downlink CCs
M_{sc,CC}_{ⱼ}^{PUSCH} may be the scheduled bandwidth for PUSCH transmission in the current sub-frame for the transport block in the j-th UL CC in which HARQ ACK is transmitted in terms of number of subcarriers
N_{symb,CC}_{ⱼ}^{PUSCH-initial} may be the number of SC-FDMA symbols per subframe for initial PUSCH transmission for the same transport block in j-th UL CC in which HARQ ACK is transmitted given by

N_{symb,CC}_{ⱼ}^{PUSCH-initial}=(2·(N_{symb}^{UL}−1)−N_{SRS,CC}_{ⱼ})
N_{SRS,CC}_{ⱼ} may be equal to 1 if UE is configured to send PUSCH and SRS in the same subframe for initial transmission in the j-th UL CC in which HARQ ACK is transmitted or if the PUSCH resource allocation for initial transmission even partially overlaps with the cell-specific SRS subframe and bandwidth configuration. Otherwise N_{SRS,CC}_{ⱼ} may be equal to 0, for example.
C_{CC}_{ⱼ} may be the number of code blocks for the transport block in the j-th UL CC in which HARQ-ACK/NAK is sent
K_{r,CC}_{ⱼ} may be the number of bits for the r-th code block for transport block in the j-th UL CC in which HARQ-ACK/NAK is sent
M_{sc,CC}_{ⱼ}^{PUSCH-initial}, C_{CC}_{_{j,}}, and K_{r,CC}_{ⱼ} may be obtained from the initial PDCCH for the same transport block in the j-th UL CC in which HARQ ACK is transmitted. If there is no initial PDCCH with DCI format 0 for the same transport block in the j-th UL CC in which HARQ ACK is transmitted, M_{sc,CC}_{ⱼ}^{PUSCH-initial}, C_{CC}_{_{j,}}, and K_{r,CC}_{ⱼ} may be determined from:
   the most recent semi-persistent scheduling (SPS) assignment PDCCH, when the initial PUSCH for the same transport block may be semi-persistently scheduled in the j-th UL CC in which HARQ ACK is transmitted; and/or
   the random access response grant for the same transport block, when the PUSCH in the j-th UL CC in which HARQ ACK is transmitted may be initiated by the random access response grant.

The previous illustrative embodiment is one representative example of how to modify O″. This embodiment may be applicable to individual coding, joint coding, or methods thereof, for example.

Embodiments contemplate that it may be desirable to maintain constant energy per UCI bit and/or per data bit. Embodiments that describe maintaining constant energy per UCI bit and/or per data bit may be equally applicable to any combination of UCI for HARQ ACK/NACK and/or CQI/PMI/RI, although the embodiments may be described in terms of HARQ ACK/NACK bits.

Embodiments contemplate that a large (or larger) fraction of coded symbols of PUSCH may be used. An UE may determine that a number of coded symbols Q′ for ACK/NACK (or RI) may exceed the maximum possible for an R8/9 operation (i.e., 4M_{sc}^{PUSCH}), possibly when at least one of the following conditions is met:
The number of ACK/NACK bits or RI bits (O) is higher than a threshold (for instance larger than 4);
The scheduled bandwidth for PUSCH transmission (in terms of sub-carriers, M_{sc}^{PUSCH}, or alternatively in terms of resource blocks M^{PUSCH} is lower than a threshold;
The quantity

$$⌈ \frac{O \cdot {M}_{sc}^{PUSCH - initial} \cdot {N}_{symb}^{PUSCH - initial} \cdot {β}_{offset}^{PUSCH}}{{\sum }_{r = 0}^{C - 1} {K}_{r}} ⌉ exceeds 4 {M}_{sc}^{PUSCH} ;$$

and/or
The control data is sent without UL-SCH data.

When at least one of the above conditions is met, the number of coded symbols may be calculated as

$${Q}^{′} = min ( ⌈ \frac{O \cdot {M}_{sc}^{PUSCH - initial} \cdot {N}_{symb}^{PUSCH - initial} \cdot {β}_{offset }^{PUSCH}}{{\sum }_{r = 0}^{C - 1} {K}_{r}} ⌉ , S \cdot {M}_{sc}^{PUSCH} ) \qquad ( 12 )$$

where S is a constant (by way of example and not limitation, higher than 4).

When the number of coded symbols may exceed 4M_{sc}^{PUSCH} according to the above, the UE may utilize the following symbols for transmission of ACK/NACK or RI:
Resources corresponding to a modified “Column set”, wherein a Column may correspond to set of symbols that are aligned in the time domain, and a column set may include a grouping of the columns. Embodiments contemplate that a column set may correspond to a set of symbols that may be used for carry information. An exemplary embodiment could include more than 4 columns (up to S columns, for example), in the column set.
   The Column set for ACK/NACK or RI may include some or all the columns used in R8/9 operation for ACK/NACK or RI respectively, for example;
   In the case where RI is not transmitted in a sub-frame, the column set for ACK/NACK may include one or more columns included in the column set of RI in R8/9 operation, for example;
   In the case where ACK/NACK is not transmitted in a sub-frame, the column set for RI may include one or more columns included in the column set of RI in R8/9 operation, for example.

An interleaving method, which may facilitate error correction to other signal processing techniques, may be used along with the modified Column set. Alternatively, interleaving may be such that all columns included in the Column set used in R8/9 operation are used before the other columns.

Alternatively, embodiments contemplate that a UE may adjust its transmission power for PUSCH transmission to ensure that the energy per information bit for ACK/NACK or RI is kept constant or approximately constant regardless of the number of UCI bits. The UE may achieve this by applying a power adjustment that is a function of the number of ACK/NACK bits (and/or RI bits). The power adjustment may be relative to the transmission power calculated according to one of the methods known by those skilled in the art. Alternatively, the UE may calculate the transmission power utilizing a formula that consists of a formula used in the prior art, with the addition of a term which consists of the power adjustment.

The power adjustment may be calculated according to at least one of the following methods:
The UE may adjust its transmission power (in dB units) by an offset 10 log 10(O/Oref) where O is the number of information bits for ACK/NACK or RI and Oref is a constant that may correspond to the maximum possible value of 0 in R8/9 (e.g., 4 for A/N).
   This method may be used in conjunction with the method of calculating the number, of symbols (for ACK/NACK or RI) Q′ using the same formula as in R8/9 but setting the value of O to Oref;
   O may correspond to the number of ACK/NACK bits in case the number of symbols (according to the R8/9 formula) Q′ is highest for A/N bits when O may equal Oref is used in this formula;
   O may correspond to the number of rank indication bits in case the number of symbols (according to the R8/9 formula) Q′ is highest for rank indication bits when O=Oref is used in this formula.

Embodiments contemplate that the UE may adjust its transmission power (in dB units) by the following offset:
In the case where Q^{need}>4M_{sc}^{PUSCH}, the power offset may be calculated as

$$10 log 10 ( \frac{{Q}^{need}}{4 {M}_{sc}^{PUSCH}} ) ( in dB units ) ;$$

Otherwise, the offset may be zero dB (i.e., no power adjustment).
   Where Q^{need} may correspond to the number of symbols in PUSCH that would be required to maintain the energy per ACK/NACK bit (or RI bit) the same for all values of O. For instance, in the single antenna case, this may be calculated as:

$${Q}^{need} = ⌈ \frac{O \cdot {M}_{sc}^{PUSCH - initial} \cdot {N}_{symb}^{PUSCH - initial} \cdot {β}_{offset}^{PUSCH}}{{\sum }_{r = 0}^{C - 1} {K}_{r}} ⌉ \qquad ( 13 )$$

The value of Q^{need} used in the power adjustment may correspond to the highest of the value obtained with O and β_{offset}^{PUSCH} corresponding to ACK/NACK bits and the value obtained with O and β_{offset}^{PUSCH} corresponding to rank indication bits. This embodiment may be used in conjunction with the same method as in R8/9 for calculating the number of symbols Q′ for ACK/NACK bits or RI bits.

Embodiments contemplate that the described power adjustments may be applied when at least one of the following conditions is met:
The number of ACK/NACK bits or RI bits (O) may be higher than a threshold (for instance larger than Oref);
The scheduled bandwidth for PUSCH transmission (in terms of sub-carriers, M_{sc}^{PUSCH}, or alternatively in terms of resource blocks M^{PUSCH}) may be lower than a threshold;
The quantity Q^{need} may exceed 4M_{sc}^{PUSCH} for either rank indication bits or A/N bits; and/or
The control data may be sent without UL-SCH data.

Alternatively, embodiments contemplate that a UE may be configured to adjust its transmission power for PUSCH transmission to perhaps ensure that the energy per information bit for the data bits (i.e. from transport block) may be kept to approximately the same level as when UCI is not included in the PUSCH. This may also compensate for the loss of coding gain in case the effective coding rate of the data may significantly increase as a result of UCI inclusion, for example.

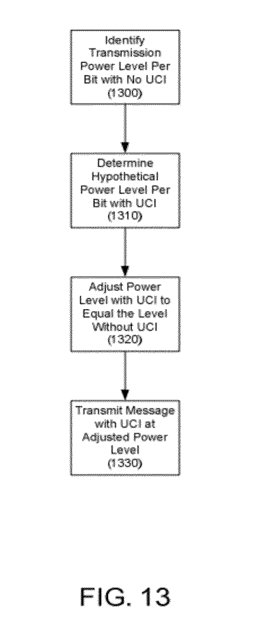

FIG. 13 illustrates an exemplary method that may adjust the power level of a data transmission which may include UCI. At 1300, the power level per bit of a transmission that does not include UCI may be identified. At 1310, the expected power level per bit may be identified for a transmission that may contain UCI data. In an exemplary embodiment, at 1320, the power level of the transmission containing UCI data may then be adjusted so that the power level per bit may be substantially similar to the power level per bit of the previous transmission which did not include UCI data. At 1330, the transmission which may contain UCI data may then transmitted at the adjusted power level per bit.

More specifically, embodiments contemplate that the transmission power of PUSCH may be adjusted as a function of at least one of the following: whether a specific type of UCI may be included in the PUSCH including whether CQI or CQI/PMI may be included in the PUSCH, whether a certain reporting mode of CQI may be used (e.g. an reporting mode used for aperiodic CQI), whether CQI is reported for a certain number of carriers, and/or any combination of CQI, PMI, RI, ACK/NACK; the total number of UCI bits; the number of CQI/PMI information bits; the number of Ack/Nack information bits; the size of the (unique) transport block (number of data bits) in case of single codeword transmission; the size of the transport block (number of data bits) for each codeword, in case of multiple codeword transmission; the number of RI information bits; the number of PUSCH symbols used for transmission of CQI/PMI; the number of PUSCH symbols used for transmission of RI; the number of PUSCH symbols used for transmission Ack/Nack; the number of PUSCH symbols used for transmission of data (from transport block(s)); the total number of PUSCH symbols used for transmission of UCI; the total number of symbols in the PUSCH transmission; the modulation order of the symbols in the PUSCH transmission; the number of DL carriers for which UCI is transmitted; and/or a value provided by higher layers. Embodiments contemplate that whether any adjustment may be performed may also be a function of one or a combination of the above parameters.

Embodiments contemplate that the UE may apply a power adjustment based on at least one value ΔUCI provided by higher layers, where the adjustment (and the choice of the value, if more than one is provided) may be applied depending on the specific type of UCI information included (if any). By way of example, and not limitation, specific values may be provided for one or more of the following cases:

CQI may be included;

Aperiodic CQI may be included (i.e. the CQI request field was set in the corresponding grant);

CQI may be included for a number of DL carriers;

RI may be included;

ACK/NACK may be included; and/or

Any combination of the above

Embodiments contemplate that a power adjustment ΔUCI (expressed in dB for example) may be calculated as:

ΔUCI=10 log₁₀[Q_{TOT}/(Q_{TOT}−Q_{UCI})]

Where Q_{TOT} may be the total number of symbols in the PUSCH transmission, and Q_{UCI} may be at least one of:

The number of PUSCH symbols used for transmission of CQI/PMI, and/or

The number of PUSCH symbols used for transmission of UCI

Alternatively, embodiments contemplate that a power adjustment ΔUCI (expressed in dB for example) is calculated as follows:

ΔUCI=10 log₁₀[Q_{TOT}/(Q_{TOT}−Q_{UCI})]+f(Q_{UCI}, Q_{TOT})

Where f may take into account the loss of coding gain caused by an increase of effective coding rate when UCI may be included. The factor f may be provided by higher layers and may be one of several values that the UE chooses from based on any of the parameters described previously, such as but not limited to, the modulation order of the PUSCH transmission, and/or the number of codewords, among others.

The power adjustments described may be applied on top of any adjustment or calculation of transmission power known to those of ordinary skill in the art. By way of example, and not limitation, the power adjustment may be according to the following formula:

P_{PUSCH}(i)=min{P_{CMAX},10 log₁₀(M_{PUSCH}(i))+P_{O}_{_{—}}_{PUSCH}(j)+α(j)·PL+Δ_{TF}(i)+f(i)+Δ_{UCI}}

where
P_{CMAX}, may be the configured maximum UE transmitted power;
M_{PUSCH}(i) may be the bandwidth of the PUSCH resource assignment expressed in number of resource blocks valid for subframe i;
P_{O}_{_{—}}_{PUSCH}(j) may be a parameter composed of the sum of a cell specific nominal component;
For j=0 or 1, αε{0, 0.4, 0.5, 0.6, 0.7, 0.8, 0.9, 1} may be a 3-bit cell specific parameter provided by higher layers. For j=2, α(j)=1;
PL may be the downlink pathloss estimate calculated in the UE in dB
Δ_{TF}(i)=10 log₁₀((2^{MPR·K}^{_{S}}−1)β_{offset}^{PUSCH}) for K_{S}=1.25 and 0 for K_{S}=0 where K_{S} may be provided by higher layers
f(i) may be the current PUSCH power control adjustment state for subframe i.

Embodiments contemplate that the number of UCI (e.g., ACK/NACK, RI) modulation symbols for retransmission with one or more codeword disabled may be determined. When a UE may be configured for UL multi-antenna transmission mode using two or more codewords, one codeword may be received correctly by the eNodeB, while others may fail. Upon the retransmission of the failed codeword (for example), the eNodeB may send a UL grant using the same multi-antenna transmission mode, but with one codeword enabled, and one codeword disabled. In other words, no new TB may be transmitted by the UE on the disabled codeword. It may be required how to determine the number of UCI (ACK/NACK, RI) symbols to be transmitted on the enabled CW. In an embodiment, this may be solved in a manner similar to other embodiments described previously. Specifically, once the β_{offset}^{HARQ-ACK} is determined for the current configuration (1 CW and one or more layers), the number of UCI symbols to be transmitted on the enabled CW may be calculated using formula (7), with B=1, for example.

In an embodiment, different β_{offset}^{HARQ-ACK} values may be used across codewords. For a multi-antenna multi-codeword transmission, the SINR may be different across the codewords, which leads to different MCS per codeword (e.g., link adaptation). To compensate for the imbalance between the SINR per codeword as well as the different MCS for each codeword, it may be useful to configure different β_{offset}^{HARQ-ACK} factors for each codeword. In an embodiment, if there is a need to use different β_{offset}^{HARQ-ACK} offset factors per codeword, such factors may be configured as follows:

Signal different I_{offset}^{HARQ-ACK} indices, one for each codeword; or

Alternately, expand the 2-D lookup table to include per codeword β_{offset}^{HARQ-ACK} factors. In this case, a single index I_{offset}^{HARQ-ACK} needs to be signaled, based on which the β_{offset}^{HARQ-ACK} factors per codeword can be readily determined.

Embodiments contemplate that the Euclidean distance of modulation symbols may be maximized. In at least a first embodiment, a UE may be configured to transmit UCI (HARQ ACK/NACK, RI) in a way that the Euclidean distance of the modulation symbols carrying UCI information are always maximized (i.e., they are mapped to the outer constellation points). In other words, in the case that the UE is configured (in an embodiment, using the AMC mechanism for example) to use a different modulation scheme for data transmissions such as QAM16 or QAM64, the modulation scheme applied for carrying UCI information may be limited to QPSK modulation regardless of the UCI payload size, the modulation order of the data codeword(s), and/or the number of codewords. As an example, denoting the control data to be transmitted on PUSCH for HARQ ACK/NACK or RI by [o₀ o₁ . . . oₒ₋₁], the encoded UCI bit sequence, wherein the channel encoder may be a Reed-Muller encoder or a tail-biting convolutional encoder, may be written as q₀, q₁, q₂, . . . , q_{Q-1} where Q may be the total number of encoded bits.

In such an embodiment, where a UE is using QAM16 modulation for data transmissions, placeholder bits may be inserted in the encoded UCI bit sequence to obtain:

[q₀ q₁ x x q₂ q₃ x x . . . q_{Q-2} q_{Q-1} x x]

Similarly, where a UE is using QAM64 modulation for data transmissions, placeholder bits may be inserted in the encoded UCI bit sequence to obtain:

└q₀ q₁ x x x x q₂ q₃ x x x x . . . q_{Q-2} q_{Q-1} x x x x┘

Eventually, the sequence may be scrambled to replace each placeholder “x” by “1”, and the resulting sequence may be modulated using the same modulation order as that of data.

Embodiments contemplate at least a second maximization of the Euclidean distance of modulation symbols, where a UE may be configured to use 16-QAM on one CW and 64-QAM on the other CW, the output of the encoder for HARQ ACK/NACK and/or RI may be scrambled (for the CW configured for 64-QAM) in such a way to effectively result in a 16-QAM like constellation. This way, both CWs may use the same 16-QAM constellation (for the HARQ ACK/NACK and/or RI symbols). This may be achieved by inserting placeholder bits (yᵢ and yᵢ₊₁) in the encoded and scrambled UCI (HARQ ACK/NACK and/or RI) bit sequence for the CW configured for 64-QAM, as follows:

[\tilde{q}₀ \tilde{q}₁ \tilde{q}₂ \tilde{q}₃ y₂ y₃ . . . \tilde{q}ᵢ₋₂ \tilde{q}ᵢ₋₁ \tilde{q}ᵢ \tilde{q}ᵢ₊₁ yᵢ yᵢ₊₁ . . . \tilde{q}_{Q-4} \tilde{q}_{Q-3} \tilde{q}_{Q-2} \tilde{q}_{Q-1} y_{Q-2} y_{Q-1}]

where [symbol] ᵢ is the channel coded and scrambled bit and the placeholder bits, yᵢ and yᵢ₊₁, may be the replicas of two previous channel encoded and scrambled bits \tilde{q}ᵢ and \tilde{q}ᵢ₊₁ respectively.

For example, for the CW configured for 64-QAM, if Q=32 and the encoded and scrambled sequence is, for example:

[\tilde{q}₀ \tilde{q}₁ \tilde{q}₂ \tilde{q}₃ . . . \tilde{q}ᵢ₋₂ \tilde{q}ᵢ₋₁ \tilde{q}ᵢ \tilde{q}ᵢ₊₁ . . . \tilde{q}₂₈ \tilde{q}₂₉ \tilde{q}₃₀ \tilde{q}₃₁]

then the padded sequence at the input of the 64-QAM modulator would be, for example:

[\tilde{q}₀ \tilde{q}₁ \tilde{q}₂ \tilde{q}₃ \tilde{q}₂ \tilde{q}₃ . . . \tilde{q}ᵢ₋₂ \tilde{q}_{q-1} \tilde{q}ᵢ \tilde{q}ᵢ₊₁ \tilde{q}ᵢ \tilde{q}ᵢ₊₁ . . . \tilde{q}₂₈ \tilde{q}₂₉ \tilde{q}₃₀ \tilde{q}₃₁ \tilde{q}₃₀ \tilde{q}₃₁]

In embodiments that maximizes the Euclidean distance of modulation symbols, when a UE is configured to use 16-QAM on one CW and 64-QAM on the other CW, the scheme in the embodiment disclosed directly above may be switched to the scheme in embodiment one, for example based on the size of Q (i.e., repetition factor), or vice versa. In such an embodiment, for example for a large repetition situation, the scheme in the first Euclidean distance maximization embodiment described previously may be used, while for a small repetition case, the scheme in the second Euclidean distance maximization embodiment described previously may be used. In this way the UE may achieve a tradeoff between coding gain (i.e., Reed-Muller encoder) and maximum Euclidean distance of modulation symbol.

Embodiments contemplate that the multiplexing of coded bits (e.g., HARQ ACK/NACK or RI) into the sub-frame may be performed, which may enhance time diversity. Such an embodiment may be used when the total number of coded bits Q_{ACK} or Q_{RI} to be transmitted in the sub-frame may exceed the size of the code block B (e.g., 32) used for generating the sequence of coded bits. In this embodiment, the sequence of Q_{ACK} or Q_{RI} coded bits may be generated by concatenating blocks of B coded bits together (in an embodiment, truncating the last block). The N+1th block of B coded bits may be obtained by a circular rotation of C bits with respect to the Nth block. The value of C may be chosen so that after multiplexing onto the sub-frame, identical coded bits are not aligned in the time domain in the symbol. In case the coded bits may be, by way of example and not limitation, multiplexed into a number of symbols in the time domain, for example 4 symbols (e.g., for HARQ ACK/NACK or RI), values of C=1, 2, or 3 would therefore be possible.

Embodiments contemplate supporting higher data rates for wireless communication technologies. The Third Generation Partnership Project (3GPP) for Long Term Evolution (LTE) has been in development to support higher data rates than that attainable with Universal Mobile Telecommunications System (UMTS) Frequency Division Duplex (FDD). LTE may support up to 100 MBPS in the downlink (DL), and 50 Mbps in the uplink (UL) for a 2×2 configuration. LTE Advanced (LTE-A) has been introduced to enable additional improvements to LTE including a five-fold improvement in DL data rates relative to those attainable with LTE. LTE-A may accomplish this by using, among other techniques, carrier aggregation. Carrier aggregation may support flexible bandwidth assignments up to 100 MHz.

For UL, LTE may be based on Discrete Fourier Transfer (DFT) Spread Orthogonal Frequency Division Multiple Access (DTF-S-OFDMA), or equivalently, Single Carrier Frequency Division Multiple Access (SC-FDMA) transmission. Since SC-FDMA may utilize the entire bandwidth for the carrier transmission, a wireless transmit/receive unit (WTRU) in the UL may transmit only on a limited, yet contiguous set of assigned sub-carriers in an FDMA arrangement. Note that when using SC-FDMA, an evolved Node-B (eNB) may receive the composite UL signal across the entire transmission bandwidth from one or more WTRUs simultaneously, but each WTRU may only transmit onto a portion of the available transmission bandwidth. In principle, DFT-S OFDM in the LTE UL may therefore be seen as a conventional form of OFDM transmission with the additional constraint that the time-frequency resource assigned to a WTRU may comprise a set of frequency-consecutive sub-carriers. In the LTE UL, there may be no DC sub-carrier (unlike the DL). Frequency hopping may be applied in one or more modes of operation to UL transmissions by a WTRU. LTE-A may extend the UL transmission bandwidth to include up to five component carriers each of which may be similar to the LTE SC-FDMA transmission format.

In an LTE-A system, more than one antenna may be supported in the UL and UL Multiple Input Multiple Output (MIMO) transmission concepts similar to the DL may also be supported.

An LTE Physical Uplink Control Channel (PUCCH) transmission may be limited to payload sizes of less than 13 bits. As noted previously, LTE-A may support UL MIMO transmission. The limited PUCCH payload sizes may lead to a need for larger UL Control channel Information (UCI) payload size. For example, to support carrier aggregation, the amount of control information may be N times larger for N carriers as compared with single carrier case. In addition, to support Cooperative MultiPoint communications (CoMP), or higher order MIMO, for example 8×8 communications, a larger Channel Quality Indicator (CQI) payload size than the payload size provided by PUCCH format 2/2a/2b may be needed.

In an LTE system, channel state information (CSI) may be designed to fit the operation of simple single-cell single user (SU)-MIMO. The CSI transmitted on PUCCH in LTE may comprise a CQI, a PMI and a Rank Indicator (RI). Due to limited PUCCH payload in LTE and only one transmit (Tx) antenna at the WTRU, the largest CSI size may be limited to 11 bits, for example 7 bits CQI plus 4 bits PMI. With concurrent transmission of Acknowledgement/Non-Acknowledgement (ACK/NACK), PUCCH payload may be limited to 13 bits, for example.

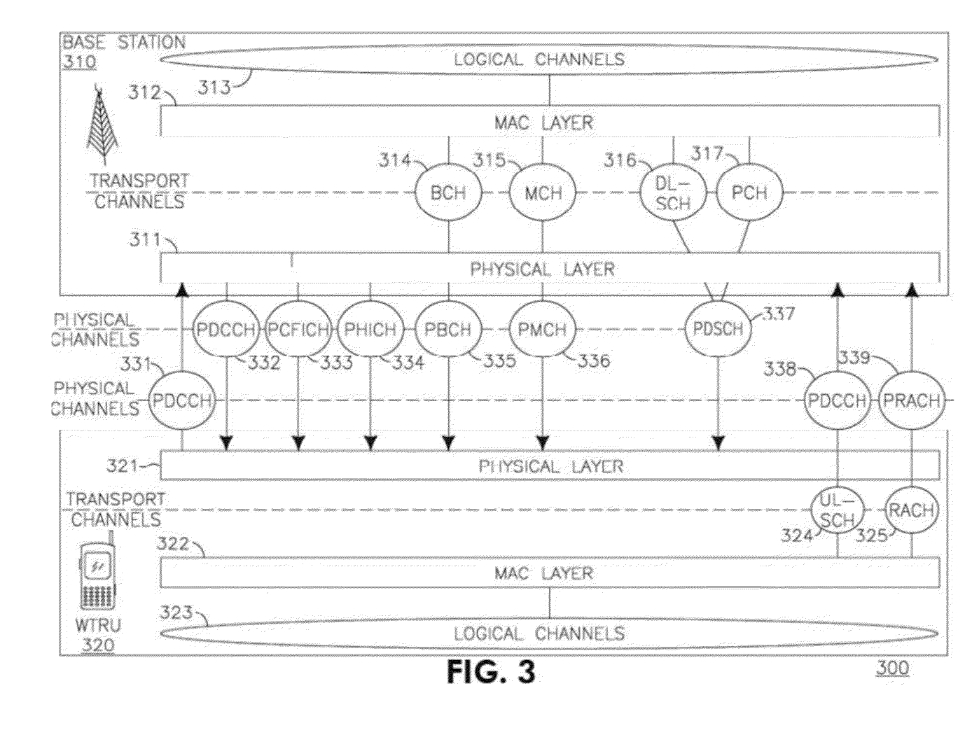

FIG. 3 is a diagram of the channels that may be used in an example LTE system 300. Referring to FIG. 3, the base station 310 may include a physical layer 311, a medium access control (MAC) layer 312, and logical channels 313. The physical layer 311 and the MAC layer 312 of the base station 310 may communicate via transport channels that may include, but are not limited to, Broadcast Channel (BCH) 314, Multicast Channel (MCH) 315, Downlink Shared Channel (DL-SCH) 316, and Paging Channel (PCH) 317. The WTRU 320 may include a physical layer 321, a medium access control (MAC) layer 322, and logical channels 323. The physical layer 321 and the MAC layer 322 of the WTRU 320 may communicate via transport channels that may include, but are not limited to, Uplink Shared Channel (UL-SCH) 324 and Random Access Channel (RACH) 325. The physical layers of the base station 310 and WTRU 320 may communicate via physical channels including, but not limited to Physical Uplink Control Channel (PUCCH) 331, Physical Downlink Control Channel (PDCCH) 332, Physical Control Format Indicator Channel (PCFICH) 333, Physical Hybrid Automatic Repeat Request Channel (PHICH) 334, Physical Broadcast Channel (PBCH) 335, Physical Multicast Channel (PMCH) 336, Physical Downlink Shared Channel (PDSCH) 337, Physical Uplink Shared Channel (PUSCH) 338, and/or Physical Random Access Channel (PRACH) 339.

The LTE devices and networks shown in FIGS. 1 through 3 are just one example of a particular communication network and other types of communication networks that may be used. The various embodiments may be implemented in any wireless communication technology. Some example types of wireless communication technologies include, but are not limited to, Worldwide Interoperability for Microwave Access (WiMAX), 802.xx, Global System for Mobile communications (GSM), Code Division Multiple Access (CDMA2000), Universal Mobile Telecommunications System (UMTS), Long Term Evolution (LTE), Advanced LTE (LTE-A), or any future technology. For purposes of explanation, the various embodiments are described in an Advanced Long Term Evolution (LTE-A) context, but the various embodiments may be implemented in any wireless communication technology.

There may be two types of “vehicles” or “containers” that may carry uplink control information (UCI), namely PUCCH and PUSCH. Aperiodic PUSCH UL control reporting may be supported in LTE. PUSCH may be dedicated to a given WTRU for UL control transmission in LTE. CDM based multiplexing may be supported for PUCCH in LTE. A single component carrier (CC) may be supported in LTE. Channel selection (CS) may be supported in TDD and may be supported in LTE-A for more than one CC, particularly for low to medium AN payload size.

Bandwidth extensions in LTE-A may be referred to as Carrier Aggregation (CA). With CA, the WTRU may transmit and receive simultaneously over the PUSCH and the PDSCH, respectively, of multiple CCs. Up to five CCs in the UL and in the DL may be used to support flexible bandwidth assignments up to 100 MHz.

In an LTE-A system, there may be several changes impacting the CSI feedback. First, CSI design may consider the CoMP case and optimized multiple user (MU)-MIMO operation. CoMP may use CSI feedback on a per cell basis (within a CoMP cell set), and MU-MIMO may use additional PMI feedback (such as best-companion PMI). Therefore, it would be desirable to increase the payload of CSI. Secondly, the introduction of multiple Tx antennas at the WTRU in LTE-A may support the increase of PUCCH payload. One of various possible solutions may be to introduce multiple orthogonal sequences (resources) for PUCCH format 2/2a/2b. This solution may support a larger size, for example, up to 30 bits (see Table 5) of PUCCH in this manner. However, multiple orthogonal sequence (resource) allocations may proportionally decrease WTRU multiplexing gain of PUCCH by assigning multiple orthogonal resources. Hence, this approach may be problematic in tight WTRUs (users) scheduling cases.

Another solution may be to allocate PUSCH to transmit large payload size of UCI. In this case, the large payload size of UCI may be too small to transmit on PUSCH. Therefore, it would be desirable to have a method and apparatus for multiplexing UCI on PUSCH, for example, to increase spectral efficiency and enhance overall system throughput. For the larger CQI reports (i.e., >13 bits) a tail-biting convolutional code (TBCC) may be used when UCI is transmitted on PUSCH. The embodiments described herein may implement multiplexing schemes for the usage of TBCC for UCI transmission on PUSCH.

TABLE 5
Summary of UCI feedback information for PUCCH payload size

| | Highly correlated | |
|---|---|---|
| | antenna | Uncorrelated antenna |
| Single-cell, SU-MIMO | 3, 8, 11 bits | 3, 10, 12, 13, 15 bits |
| Single-cell, MU-MIMO | 3, 10, 12, 13, 15 bits | 3, 12, 14, 15, 16, 17, |
| w/BC PMI | | 19 bits |
| Multiple-cell, SU-MIMO | 3, 8, 11~19 bits | 3, 10, 12~23 bits |
| Multiple-cell MU-MIMO | 3, 10, 12~28 bits | 3, 12, 14~30 bits |
| w/BC PMI | | |

There may be issues with user multiplexing for UCI transmitted on PUSCH and PUCCH. In an example, an issue for user multiplexing for UCI on PUSCH may arise due to carrier aggregation and other new features, large/variable amount of uplink control, or UCI is needed to be sent. With respect to the large/variable control size aspect, a large/variable size PUSCH container may be suitable to carry UCI due to its high capacity and flexibility. With respect to the multiplexing gain and spectrum efficiency aspect, it may be inefficient to use a dedicated PUSCH to a WTRU if UCI is not large enough to completely fill in the PUSCH resources. This may lead to two or more WTRUs sharing the same PUSCH and increase resource utilization efficiency. With respect to the overhead aspect, support of CSI feedback in the PUSCH (without user multiplexing on the same PUSCH resource) may represent a significant part of the total UL overhead about 10-20%. Accordingly, a method and device for transmitting uplink control on PUSCH container and sharing the same PUSCH resource or multiplexing different WTRUs on the same PUSCH resources would be desirable. Solution to uplink control transmission and multiplex users on the same PUSCH resource may be needed.

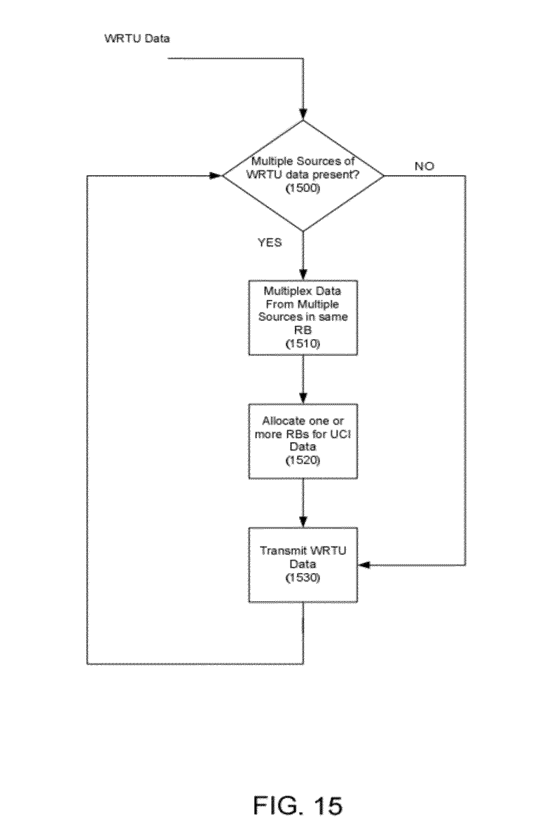

FIG. 15 illustrates an exemplary method that may multiplex multiple sources of WRTU data. At 1500, the WRTU may determine whether there are multiple sources of data ready for transmission. In one embodiment, the data from multiple sources can be UCI data. In other embodiments, the data could be UCI data and other data available for transmission. If multiple sources of data may be present, then at 1510, the data from the multiple sources can be multiplexed in the same RB. In one embodiment, one or more RBs can be allocated to UCI data at 1520. The multiplexed data can then be transmitted at 1530.

In another example, an issue for user multiplexing for UCI on PUCCH Container with Channel Selection may arise when UCI is not large enough, or when a PUCCH container may be used. For example, for small to medium AN payload size, PUCCH channel selection (CS) may be suitable. Channel selection may provide enhanced WTRU multiplexing gain due to its flexibility. CS may support 9 WTRUs per RB instead of 5 WTRUs per RB. CDM-based user multiplexing may be used for PUCCH, however this may lead to issues associated with WTRU multiplexing for PUCCH channel selection. Two important issues are identified in the examples below.

In an example, an insufficient PUCCH resource allocation may occur for user multiplexing. In some scenarios and configurations an insufficient PUCCH resource allocation may occur for CS user multiplexing. For example, for 4 ANs (e.g., 2 CCs with MIMO), 2 PDCCHs may be transmitted, thus 2 PUCCHs may be assigned to a user. For CS, 4 PUCCHs may be needed to indicate 4 ANs or 16 states. Accordingly, a solution to assign PUCCHs to support CS user multiplexing is needed.

In another example, an over-sufficient PUCCH resource allocation may occur for user multiplexing. In this example, for some scenarios and configurations, more than sufficient PUCCH resources may be allocated. For example, for 4 ANs having 4 CCs with SIMO, 4 PDCCHs may be transmitted, and therefore, 4 PUCCHs may be assigned to a user. In an enhanced CS example, 2 PUCCHs may indicate 4 ANs or 16 states. Assigning additional PUCCHs may reduce user multiplexing gain, increase overhead, and may reduce resource utilization efficiency. Accordingly, a solution to re-assign a PUCCH resource for enhanced user multiplexing is needed.

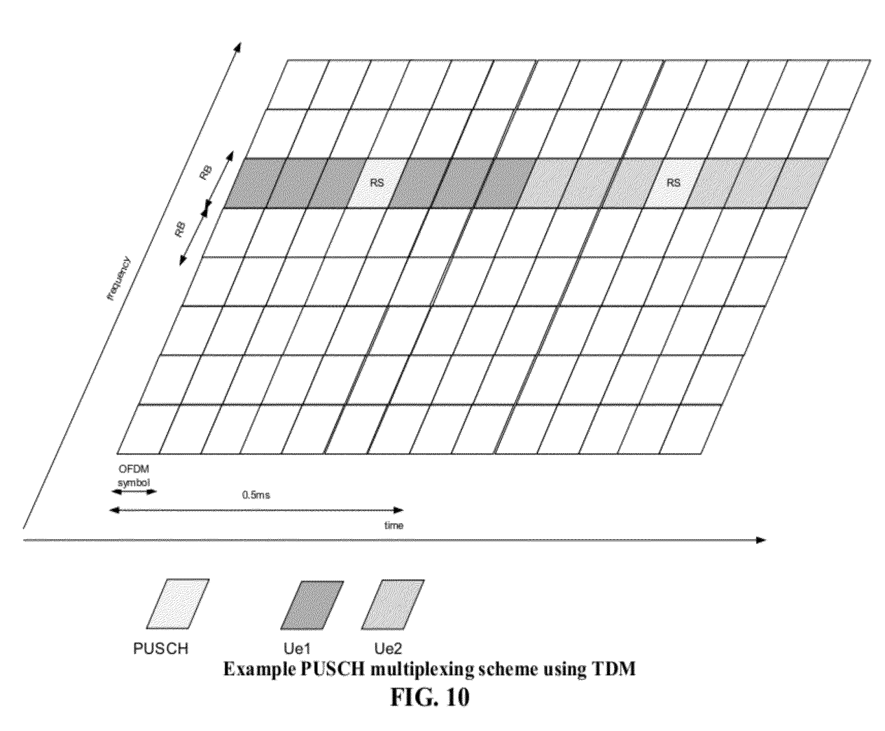

Several solutions may be implemented to enhance user multiplexing for a control channel using a PUSCH container. A first example solution may use Code Division Multiplexing (CDM) based PUSCH for UCI. CDM may be used to multiplex users in the same PUSCH resource. CDM with time-domain code division or spreading, frequency-domain code division or spreading, or a combination of time and frequency-domain code division or spreading may be used for multiplexing users in the same PUSCH resource. PUCCH structure may be overlaid onto PUSCH. This approach may be applied to any structure or format of PUCCH. For example, a PUCCH format 2/2a/2b or a DFT-S-OFDM-based format, etc. may be overlaid onto a PUSCH resource for user multiplexing and resource sharing by users in the same PUSCH resource. An example of DFT-S-OFDM format with a spreading factor (SF) of 3 is shown in FIG. 10.

The first example solution may be implemented in a variety of alternative methods. In a first alternative, the PUCCH structure may be overlaid onto PUSCH. When UCI information bits are less than a certain number of bits, e.g., 11 bits, the PUSCH may adopt a PUCCH format 2/2a/2b CDM scheme. One resource block (RB) may be used for PUSCH resource allocation in this example. If the WTRU has more than one transmit antenna, then a transmit diversity scheme such as spatial orthogonal resource transmit diversity (SORTD) or space-time block coding (STBC) may be applied. In a second alternative, when the UCI information bits are greater than certain number of bits, e.g., 11 bits; the PUSCH may extend PUCCH format 2/2a/2b CDM scheme by either assigning multiple orthogonal resources for each RB or by using a larger payload format such as DFT-S-OFDM-based format, for example.

A third alternative may use multiple sequence modulation, for example, when the UCI information bits are greater than certain number of bits, e.g., 11 bits. In this alternative, the PUSCH may extend the PUCCH format 2/2a/2b CDM scheme by assigning multiple orthogonal resources for each RB. For example, the eNB may assign multiple orthogonal sequences within one RB or in distinct RBs for a WTRU. Tail-biting convolutional codes (TBCC) may apply in this example. The effective coding rate r may be expressed as

$$r = \frac{n}{m \times 20 \times ( \frac{Q}{2} )} , \qquad Equation ( 14 )$$

where m may be the orthogonal resources allocated for PUSCH, n may be information bit size and Q may be log₂(M). M may be the value for M-QAM modulation scheme. For example, if two orthogonal sequences or resources are allocated for PUCCH format 2 and information bits n=16, the effective coding rate may be equal to

$$r = \frac{16}{2 \times 20} = \frac{2}{5} .$$

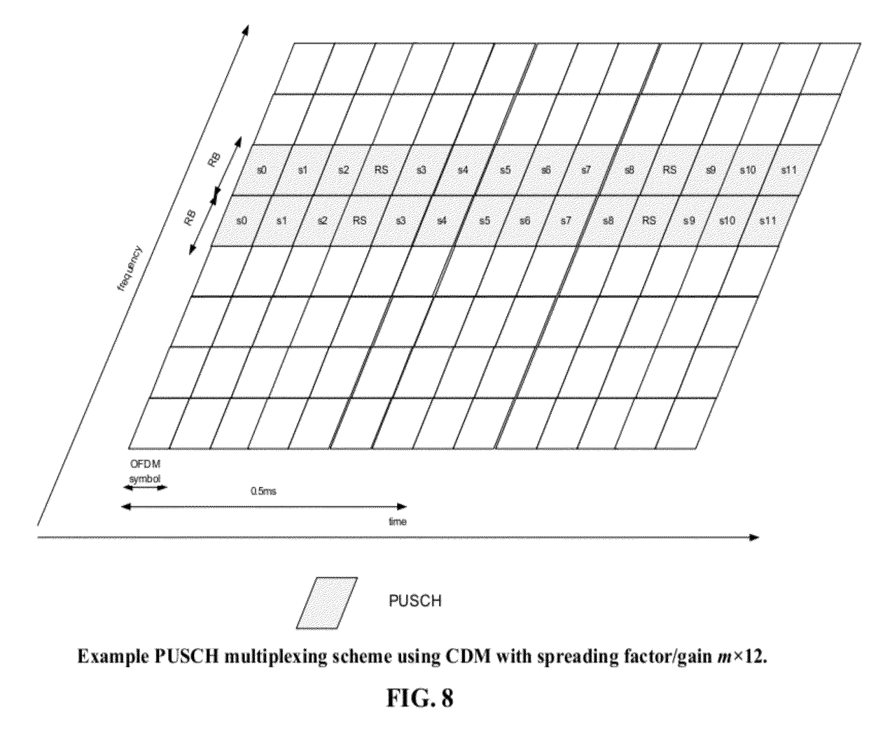

In this manner, the eNB may balance and trade-off between performance and resource allocation. FIG. 8 shows an example where the PUSCH multiplexing scheme may use or adopt a PUCCH format 2 or similar when two distinct RBs are allocated. However, in this example, a cubic metric (CM) issue may arise when multiple orthogonal sequences are assigned to the same RB. This issue, however, may be mitigated by limiting the number of assigned orthogonal sequences or resources to two at most or by using sequence modulation or precoding methods.

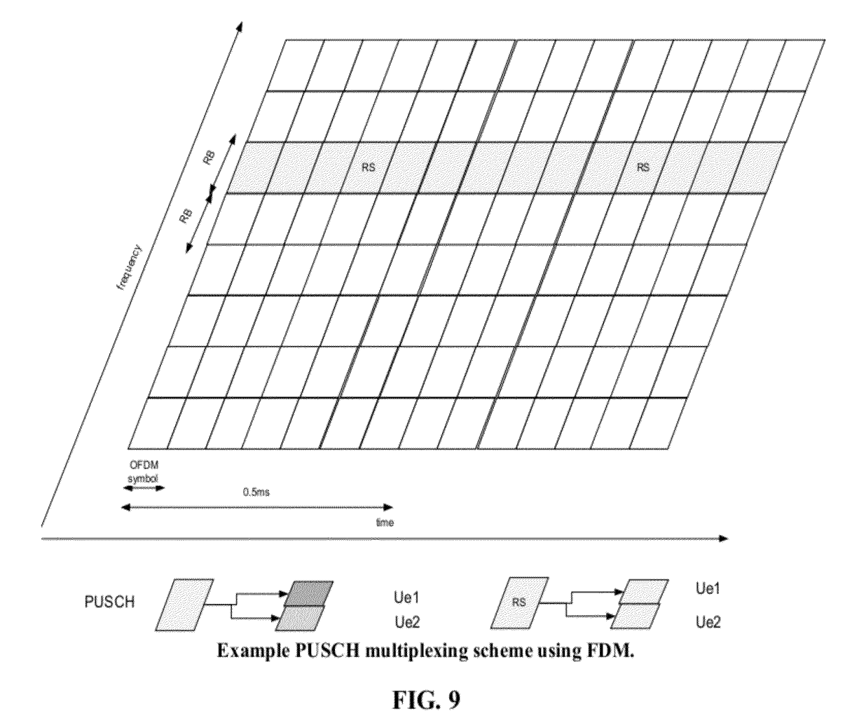

A fourth alternative may implement a spreading factor reduction. For example, a resource may be partitioned using a spreading code or orthogonal cover code. For example, the time domain SF may be reduced to support more payloads or bits per user when multiplexing multiple users, for example, multiplexing two users simultaneously in the same PUSCH resource. FIG. 9 shows an example using the time domain spreading code division in time domain with SF 2. DFT-S-OFDM based PUCCH with spreading factor reduction may be used for user multiplexing in a PUSCH container. For example, the SF may be reduced to SF=2 from SF=3 or 5. {c₁, c₂} may be a reduced SF spreading code or orthogonal cover code. The structure and format shown in FIG. 9 may also be used for a PUCCH container, for example, as a new PUCCH structure or format.

A fifth alternative may use a variable SF. For example, a variable SF may be used for flexible user multiplexing. In this alternative, at least two options may be considered. In a first option, the PUSCH may adopt a spreading gain, for example a frequency domain SF equal to 12, in a PUCCH format 2. In this example, the effective coding rate may be adjusted as

$$r = \frac{n}{m \times 24 \times ( \frac{Q}{2} )} , \qquad Equation ( 15 )$$

For example, if the number of RBs m=2 is allocated for PUSCH control, then each RB may allow 12 QPSK symbols to be transmitted as shown in FIG. 10. Since the spreading gain may be equal to 12, the spreading sequence may be adapted from DMRS for PUSCH. A minimum cyclic-shift may then equal to 2 and may allow 12/2=6 WTRUs to be simultaneously multiplexed within one RB.

In a second option, the PUSCH may use a spreading factor/gain m×12 where m may be the number of RBs allocated for PUSCH. In this option, the effective coding rate may be adjusted as

$$r = \frac{n}{24 \times ( \frac{Q}{2} )} . \qquad Equation ( 16 )$$

Since the spreading factor or gain may be equal to 12, the spreading sequence may be adapted from DMRS for PUSCH. A minimum cyclic-shift may then be equal to 2 and allow m×12/2=6 m WTRUs to be simultaneously multiplexed in the same resource. In this example, the WTRU multiplexing gain may be increased proportionally with the number of allocated PUSCH RBs. The number of DMRS may be increased from 2 to 4 in one subframe or TTI. If the DMRS is increased by a factor of 2, then the effective coding rate may be adjusted as

$$r = \frac{n}{20 \times ( \frac{Q}{2} )} . \qquad Equation ( 17 )$$

A second example solution may use Frequency Division Multiplexing (FDM) based PUSCH for UCI. In this example, the FDM based approach may be used for PUSCH multiplexing. The FDM based method may also be applied to user multiplexing for a control channel using PUCCH. A FDM+CDM based approach may also be used for PUSCH and/or PUCCH. Each WTRU may be multiplexed in the same resource or RB(s) but use different subcarriers (Sacs) within the same allocated resource or RB(s). The resource or RB(s) may be partitioned in different ways for subcarriers, and the subcarriers may be assigned according to a particular partition method. For example, resources may be partitioned into two or more segments, and each segment may contain N1 (or N2) subcarriers, etc. For a non-limiting exemplary resource partition and assignment, the first N1 subcarriers may be a one resource partition and assigned to one WTRU, the second N1 (or N2) subcarriers may be another resource partition and assigned to another WTRU, and so on. In an interleaved example, even numbered subcarriers (e.g., subcarrier #2, 4, 6, . . . , 2K) may be one resource partition and assigned to one WTRU and odd numbered subcarriers (e.g., subcarrier #1, 3, 5, . . . , 2K−1) may be another resource partition and assigned to another WTRU. Subcarrier partitioning may also be used in combination with DFT-S-OFDM and in FDM-based DFT-S-OFDM. As a non-limiting exemplary equation, the number of subcarriers assigned to one multiplexed WTRU may be expressed as

$$p = \frac{m \times 12}{q} , \qquad Equation ( 18 )$$

where q may be the total number of multiplexed WTRUs in a PUSCH and/or PUCCH resource or RB(s).

A resource containing a subset of subcarriers and a spreading code may be assigned to a WTRU for user multiplexing. DFT-S-OFDM with FDM may be applied to PUSCH as well as PUCCH container for user multiplexing purpose.

FIG. 9 shows an example in which two WTRUs may be multiplexed in a same allocated RB. The DRMS for PUSCH may be reused from an LTE structure, but it may also be shared proportionally with the number of WTRUs that may be multiplexed simultaneously in the same RB. One or more RBs for PUSCH may be allocated and used for transmitting uplink control information for multiple WTRUs. The allocated RB or RBs may also be partitioned into several segments either in frequency, time, or combination of both, and each WTRU may access one or more frequency and/or time segments for transmitting uplink control information. The resource partition(s) or segment(s) within the RB or RBs may be indicated by higher layer signaling, for example RRC signaling, L1/2 signaling, or PDCCH if desired. The location of the RB or RBs that are allocated to a WTRU may be indicated by a resource allocation control field in PDCCH, for example, in a DCI format. The partitions or segments within the allocated RB or RBs to be assigned to a WTRU may be indicated using a resource partition index or a resource segment index. Different users may be multiplexed together by assigning different partitions or partition indices or segments or segment indices in the same allocated RB for PUSCH and/or PUCCH. The resource partitions or segments within RB or RBs may be interleaved or sparse, or the similar, for diversity.

In alternatives, FDM may be combined with DFT-S-OFDM for PUCCH and/or PUSCH. For example, resource partitioning may be performed in a DFT-S-OFDM-based format, as described above. FDM based DFT-S-OFDM may be used for PUCCH or PUSCH. For example, DFT-S-OFDM or the like with time-domain spreading code and frequency-domain (subcarrier) partitioning may be used. Resources may be partitioned into several partitions or segments, for example, Q partitions or segments using combined FDM and CDM where Q=Q1×Q2, Q1 may be the number of spreading codes and Q2 may be the number of subcarrier partitions. As a non-limiting example, Q1=2 for spreading codes of SF=2 may be used for code-domain partitioning, while frequency (subcarrier) partitions containing either even or odd numbered subcarriers (i.e., Q2=2) may be used for frequency-domain (subcarrier) partitioning. This may result in an example with four frequency/code resource partitions as follows:

Partition#1: time-domain spreading code index=0 and subcarrier#1, 3, 5, . . . , 2K−1 (odd)

Partition#2: time-domain spreading code index=1 and subcarrier#1, 3, 5, . . . , 2K−1 (odd)

Partition#3: time-domain spreading code index=0 and subcarrier#2, 4, 6, . . . , 2K (even)

Partition#4: time-domain spreading code index=1 and subcarrier#2, 4, 6, . . . , 2K (even)

Spreading codes of any SF such as SF=3 or SF=5 may also be used for code-domain resource partitioning. A combination of subcarrier partitioning and code division use of spreading code with SF may be used for user multiplexing purpose for PUCCH as well as PUSCH. Linear block coding such as Reed Muller (RM) coding with rate matching may be used for resource partitioning and assignment to a WTRU. Non-linear coding such as convolutional coding or tail biting convolutional coding (TBCC) may be used.

A third example solution may use Time Division Multiplexing (TDM) based PUSCH for UCI. In a TDM based multiplexing scheme, the WTRUs may be allowed to transmit PUSCH control information at different times (or time symbols) within one subframe or TTI. This method may be applied to user multiplexing for a control channel using PUCCH, for example a PUCCH format 2. The transmit timing may be predefined or configurable. For example, the time resource may be partitioned in such way that the first N1 symbols may be one partition and assigned to one WTRU, the second N1 (or N2) symbols may be another partition and may be assigned to another WTRU, and so on. In an interleaved example, the even numbered symbols (e.g., symbol#2, 4, . . . , 2K) may be one partition and assigned to one WTRU and the odd numbered symbols (e.g., symbol#1, 3, 2K−1) may be another partition and assigned to another WTRU, and so on. The DMRS may be time shared since it uses time-multiplexing. If necessary, the DMRS may use CDM, for example, using cyclic-shift of CAZAC codes to enhance channel information estimation. A simple non-limiting exemplary TDM scheme with two WTRUs being multiplexed in a same PUSCH and/or PUCCH resource or RB using TDM-based approach is shown in FIG. 10.

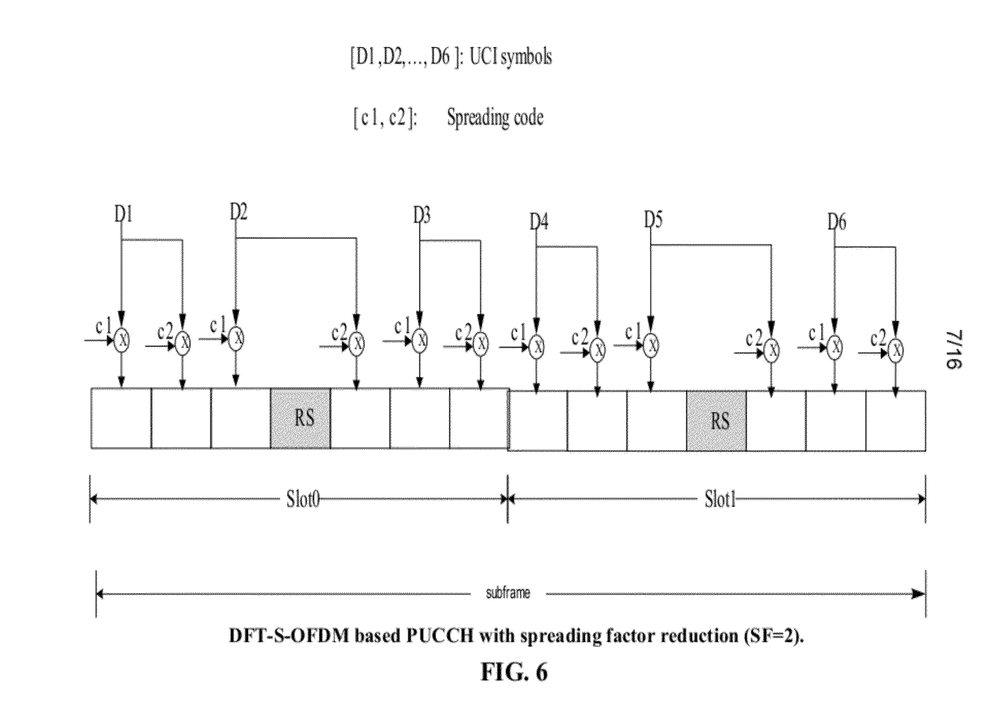

In alternatives, TDM may be combined with DFT-S-OFDM for PUCCH and/or PUSCH. In this example, resource partitioning may be performed for a DFT-S-OFDM-based format using TDM. TDM based DFT-S-OFDM may be used for PUCCH as well as PUSCH. For example, DFT-S-OFDM or the like with time-domain spreading code and time-domain symbol partitioning may be used. Resources may be partitioned into Q (Q=Q1×Q2) partitions or segments using combined TDM and CDM, where Q1 may be the number of spreading codes and Q2 may be the number of partitions for time symbols. For example, Q=6 partitions or segments (where Q1=3 and Q2=2) may be possible. DFT-S-OFDM with SF=3 is shown in FIG. 6. There may be fourteen time symbols in a subframe. Partitioning or assignment of time symbols to a WTRU may be performed across two or more timeslots in a subframe to achieve frequency diversity, for example for PUCCH.

As a non-limiting example, spreading codes of SF=3 may be used for code-domain partitioning, while subsets of time symbols, such as partitioning of SC-FDMA symbols, may be used for time-domain resource partitioning. This may result in the six combined time/code (TDM/CDM) resource partitions that may support Q=6 users per RB for user multiplexing as follows:

Partition#1: time-domain spreading code index=0 and SC-FDMA symbol#0, 1, 2, 6, 7, 8
Partition#2: time-domain spreading code index=1 and SC-FDMA symbol#0, 1, 2, 6, 7, 8
Partition#3: time-domain spreading code index=2 and SC-FDMA symbol#0, 1, 2, 6, 7, 8
Partition#4: time-domain spreading code index=0 and SC-FDMA symbol#3, 4, 5, 9, 10, 11
Partition#5: time-domain spreading code index=1 and SC-FDMA symbol#3, 4, 5, 9, 10, 11
Partition#6: time-domain spreading code index=2 and SC-FDMA symbol#3, 4, 5, 9, 10, 11

Different time symbol partitioning may be possible. Time symbols may be partitioned into four partitions (Q2=4), for example, SC-FDMA symbols#0, 1, 2 as one partition, SC-FDMA symbols#3, 4, 5 as one partition, SC-FDMA symbols#6, 7, 8 as another partition, and SC-FDMA symbols#9, 10, 11 as another partition. When combined with time-domain spreading code (of e.g., SF=3), Q=12 resource partitions may be created that may support twelve users per RB for user multiplexing. Other examples may also be derived using combination of time division and code division multiplexing that may be applied to PUSCH and/or PUCCH.

Alternatively, TDM may be combined with PUCCH format 2 for PUCCH and/or PUSCH. In this example, resource partitioning may be performed for PUCCH format 2 (or 2a/2b) using time division. A TDM-based PUCCH format 2 (or 2a/2b) may be used for PUCCH container as well as a PUSCH container. For example, PUCCH format 2 or the like with time-domain symbol partitioning or assignment may be used. SC-FDMA symbols may be partitioned into several partitions. Resources may be partitioned into several partitions or segments using combined TDM and frequency-domain CDM. As a non-limiting example, cyclic shift codes of SF=12 may be used for code domain partitioning, while partitioning of time symbols, for example SC-FDMA symbols, may be used for time-domain resource partitioning. This may result in Q (=Q1×Q2) combined TDM/CDM resource partitions that may support Q users per RB for user multiplexing, where Q1 may be the number of cyclic shift codes and Q2 may be the number of partitions of SC-FDMA symbols per RB. An non-limiting example for Q=12 (Q1=6 and Q2=2) for TDM based PUCCH format 2 may be shown as follows:

Partition#1: cyclic shift code index=0 and odd numbered SC-FDMA symbol

Partition#2: cyclic shift code index=0 and even numbered SC-FDMA symbol

Partition#3: cyclic shift code index=1 and odd numbered SC-FDMA symbol

Partition#4: cyclic shift code index=1 and even numbered SC-FDMA symbol

Partition#5: cyclic shift code index=2 and odd numbered SC-FDMA symbol

Partition#6: cyclic shift code index=2 and even numbered SC-FDMA symbol

Partition#7: cyclic shift code index=3 and odd numbered SC-FDMA symbol

Partition#8: cyclic shift code index=3 and even numbered SC-FDMA symbol

Partition#9: cyclic shift code index=4 and odd numbered SC-FDMA symbol

Partition#10: cyclic shift code index=4 and even numbered SC-FDMA symbol

Partition#11: cyclic shift code index=5 and odd numbered SC-FDMA symbol

Partition#12: cyclic shift code index=5 and even numbered SC-FDMA symbol

Different time symbol partitioning may be possible. Time symbols may be partitioned into three partitions (Q2=3), for example, SC-FDMA symbols#0, 3, 6, 9 as one partition, SC-FDMA symbols#1, 4, 7, 10 as one partition, and SC-FDMA symbols#2, 5, 8, 11 as another partition. When combined with Q1 cyclic shift codes (e.g., Q1=6), eighteen resource partitions using time and code division may be created that may support eighteen users per RB for user multiplexing. Other examples may also be derived using combination of time division and frequency-domain code division (e.g., cyclic shift code) multiplexing, that may be applied to PUSCH and/or PUCCH. Linear block coding such as Reed Muller (RM) coding with rate matching or modified RM coding may be used for resource partitioning and assignment to the WTRU. Non-linear coding such as convolutional coding or tail biting convolutional coding (TBCC) may be used.

Spatial Division Multiple Access (SDMA) may be used for UCI transmission. A DFT-S-OFDM scheme for control transmission under carrier aggregation may be used for multiplexing up to maximum five WTRUs per RB as a result of using a time-domain orthogonal spreading code of length 5 on data. Therefore, its PUCCH multiplexing capacity may be reduced by a factor of seven as compared with the multiplexing capacity of PUCCH format 1/1a/1b.

Accordingly, an uplink Multi-User Multiple-Input-Multiple-Output (MU-MIMO) system that includes multiple WTRUs transmitting on the same set of RBs (i.e., using the same frequency- and time-domain resources) may be employed for control channel transmissions in LTE-A and beyond. Utilizing frequency-domain cyclic shifts (CS) together with time-domain orthogonal cover codes (OCC) for Demodulation Reference Symbols (DM-RS) multiplexing may enable the eNodeB to derive independent channel estimates for the uplink control transmissions from multiple WTRUs. Based on this approach, the orthogonality among the WTRUs for control information transmission may be achieved through SDMA. This mode of operation implies that multiple WTRUs transmitting on the same set of RBs may be assigned with an identical orthogonal code for spreading of control information.

More specifically, the eNB may first process the feedback received from multiple WTRUs in the uplink, such as sounding signals, and then assign a PUCCH resource index to each WTRU from which the WTRU may derive the assigned cyclic time shift together with the OCC index for DM-RS and the OCC index for data spreading. Accordingly, no additional signaling may be needed to support MU-MIMO for uplink control transmissions.

A fourth example solution may use a combination of code, frequency and/or Time Division Multiplexing (TDM) based PUSCH for UCI. A combined CDM and FDM and/or TDM methods may be used for multiplexing users or sharing the resource in the same PUSCH container or resource. For example, a combined CDM and FDM, CDM and TDM, or FDM and TDM may be used. A multiplexing scheme that uses the combination of CDM, FDM and TDM may also be possible. Methods for CDM, FDM and TDM within the same PUSCH resource are described previously. These combination methods (FDM, CDM and TDM) may also be applied to PUCCH such as PUCCH format 2/2a/2b, DFT-S-OFDM based format or other PUCCH formats.

In a second alternative, FDM/TDM/CDM may be combined with DFT-S-OFDM for PUCCH and/or PUSCH. Resource partitioning may be performed for DFT-S-OFDM-based format using time, frequency and code division. TDM+FDM+CDM based DFT-S-OFDM may be used for PUCCH as well as PUSCH. For example, DFT-S-OFDM or the like with combined time-domain spreading code, frequency-domain subcarrier partitioning and time-domain symbol partitioning may be used. Resources may be partitioned into Q (=Q1×Q2×Q3) partitions or segments using combined FDM, TDM and CDM, where Q1 may be the number of spreading codes, Q2 may be the number of time symbol partitions and Q3 may be the number of subcarrier partitions. DFT-S-OFDM with SF=3 is shown in FIG. 6. As a non-limiting example, Q1 (Q1=3) spreading codes (of e.g., SF=3) may be used for code-domain partitioning, while partitioning of subcarriers (Q3=2) and time symbols (e.g., SC-FDMA symbol) (Q2=2) may be used for combined frequency/time-domain resource partitioning. This may result in Q=12 (3×2×2) combined frequency/time/code (FDM/TDM/CDM) resource partitions that may support up to twelve users per RB for user multiplexing as follows:

Partition#1: time-domain spreading code index=0, odd numbered subcarriers and SC-FDMA symbol#0, 1, 2, 6, 7, 8.

Partition#2: time-domain spreading code index=0, even numbered subcarriers and SC-FDMA symbol#0, 1, 2, 6, 7, 8.

Partition#3: time-domain spreading code index=1, odd numbered subcarriers and SC-FDMA symbol#0, 1, 2, 6, 7, 8.

Partition#4: time-domain spreading code index=1, even numbered subcarriers and SC-FDMA symbol#0, 1, 2, 6, 7, 8.

Partition#5: time-domain spreading code index=2, odd numbered subcarriers and SC-FDMA symbol#0, 1, 2, 6, 7, 8.

Partition#6: time-domain spreading code index=2, even numbered subcarriers and SC-FDMA symbol#0, 1, 2, 6, 7, 8.

Partition#7: time-domain spreading code index=0, odd numbered subcarriers and SC-FDMA symbol#3, 4, 5, 9, 10, 11.

Partition#8: time-domain spreading code index=0, even numbered subcarriers and SC-FDMA symbol#3, 4, 5, 9, 10, 11.

Partition#9: time-domain spreading code index=1, odd numbered subcarriers and SC-FDMA symbol#3, 4, 5, 9, 10, 11.

Partition#10: time-domain spreading code index=1, even numbered subcarriers and SC-FDMA symbol#3, 4, 5, 9, 10, 11.

Partition#11: time-domain spreading code index=2, odd numbered subcarriers and SC-FDMA symbol#3, 4, 5, 9, 10, 11.

Partition#12: time-domain spreading code index=2, even numbered subcarriers and SC-FDMA symbol#3, 4, 5, 9, 10, 11.

Different subcarrier and time symbol partitioning may be possible. If subcarriers and time symbols are partitioned into eight partitions (Q2×Q3=2×4), when combined with time-domain spreading code of SF=3, up to twenty four (Q=24 or 3×2×4) resource partitions may be created that may support up to twenty four users per RB for user multiplexing. Other examples may also be derived using combination of frequency division, time division and code division multiplexing which may be applied to PUSCH and/or PUCCH.

Once the resources (e.g., RBs) are partitioned either in time, frequency and/or code, or combination of time, frequency and code, users may access different resource partitions within the same PUSCH resource or PUCCH resource by assigning different partition or partition index to the WTRUs.

This resource partitioning method for DFT-S-OFDM format may also be used for PUCCH, instead of PUSCH, to increase the user multiplexing gain. For low to medium AN range, for example, low degree carrier aggregation such as two component carriers are aggregated, user multiplexing gain may be critical. By allowing WTRUs to access different resource partitions in the same PUCCH RB may significantly increase user multiplexing gain by many folds as compared to the schemes without resource partitioning and sharing for users. Linear block coding such as Reed Muller (RM) coding with rate matching may be used for resource partitioning and assignment to the WTRU. Non-linear coding such as convolutional coding or tail biting convolutional coding (TBCC) may be used.

DMRS may be taken into account. The number of DMRSs may be increased by using CDM or TDM for PUSCH and/or PUCCH. Orthogonal cover code, for example, applied to DMRS symbols within a timeslot or subframe, may be used to increase the number of DMRSs. Orthogonal cover codes may be [+1 +1] and [+1 −1]. Alternatively, (time-domain) DMRS symbols may be assigned to different WTRUs to support more users. For example, the first DMRS symbol (with a cyclic shift code) may be assigned to user 1 and the second DMRS symbol (with the same or different cyclic shift code as the first DMRS symbol) may be assigned to user 2, and so on.

CDM or TDM for DFT-S-OFDM format may also be used for PUCCH to increase the user multiplexing gain. In this manner, the number of DMRS (or orthogonal sequences) may be greater than user multiplexing. For example, when UL-MIMO is available for a WTRU, DFT-S-OFDM may disable slot hopping such that an orthogonal covering code may be applied on both time slots in the subframe, hence, even DFT-S-OFDM format with SF=3, the user multiplexing gain may be doubled by using orthogonal covering code on DMRS. Since orthogonal covering code may be applied on DMRS for DFT-S-OFDM format with SF=5, the spared DMRS orthogonal sequences may be adopted to support larger user multiplexing gain. In addition, if TDM is to increase user multiplexing gain for DFT-S-OFDM format with SF=5, then one of DMRS may be reserved in a time slot to double user multiplexing gain.

Configuration and resource allocation may be taken into account. One or more RBs for PUSCH may be allocated and used for transmitting uplink control information for one or multiple WTRUs. Allocated resources may also be partitioned into segments, either in code, frequency, time or a combination of code, frequency and/or time. Each WTRU may access one or more partitions or segments within the same allocated resource for transmitting uplink control information. The resource segment or segments within the same RB or RBs may be indicated by higher layer signaling such as RRC signaling or L1/2 signaling such as PDCCH. The resource address for PUSCH resources may be indicated by a resource allocation control field in PDCCH (DCI format). Another method may be to use a fixed resource allocation (RA), for example a fixed or predetermined resource RB/RBG. Yet another method may include RA bits in RRC signaling or configuration. For example, PUSCH resource allocation may be performed by higher layer signaling/configuration. In this method, resource allocation may be more flexible than fixed RA, but may be less flexible than dynamic DCI based RA.

The resource partition/segment may be assigned using an index. The resource partition/segment within the same RB or RBs may be indicated by the partition index or segment index. For example, if a resource is partitioned by code, a code index may be used to indicate the resource partition or segment the WTRU is assigned to. If a resource is partitioned by subcarrier, a frequency partition index may be used to indicate the resource partition or segment that the WTRU is assigned to. If resource is partitioned by time symbol, a time partition index may be used to indicate the resource partition or segment that WTRU is assigned to. If resource is partitioned by a combination of code, subcarrier and/or time symbol, a code-frequency partition index, frequency-time partition index, code-time partition index, or code-frequency-time partition index may be used to indicate the resource partition or segment that the WTRU is assigned to. The partition(s) or segment(s) within the RB or RBs may be interleaved or sparse for diversity. For DCI-based RA, an identifier such as code-point, flag or bit(s) in L1/2 signaling such as PDCCH, MAC, or CE may be used to distinguish between “control”-type and “data”-type PUSCH. In addition, PUCCH may be overlaid onto PUSCH to support flexible WTRU multiplexing. For example, some RB(s) may support multiplexing for K1 users, some RB(s) may support multiplexing for K2 users, and so on, as a non-limiting example.

A variety of example solutions may be implemented in user channel multiplexing for control channel using a PUCCH Container. The following solutions and alternatives may be implemented for uplink control for PUCCH using CS.

A method and device may be used for handling an insufficient PUCCH resource for User Channel Multiplexing. Insufficient PUCCH resources for CS user channel multiplexing may be addressed by applying an offset to a PUCCH resource, or by using a non-first CCE address, for example using the 2nd or 3rd CCE address, and so on, to assign or reserve an additional PUCCH resource for user channel multiplexing. Channel multiplexing may be a channel selection multiplexing using PUCCH format 1b, for example.

In a first example solution, an offset may be used to assign or reserve a PUCCH resource for HARQ feedback corresponding to serving cell, transport block or CC for a WTRU. This offset can be fixed or may be eNodeB-configurable. This example may apply an offset to a PDCCH CCE address to assign or reserve additional PUCCH resources to support CS channel multiplexing. The offset may be with respect to the first CCE address of a PDCCH or DCI. For example, the first CCE address of the first PDCCH or DCI may be used by a WTRU to assign or reserve a first PUCCH resource for a given WTRU. The offset to the first CCE address of the first PDCCH or DCI may be used by the WTRU to assign or reserve an additional PUCCH resource, for example a second PUCCH for the given WTRU. Similarly, the first CCE address of the second PDCCH may be used by the WTRU to assign or reserve a PUCCH resource, for example a third PUCCH for the given WTRU. The offset to the first CCE address of the second PDCCH may be used by the WTRU to assign or reserve an additional PUCCH resource, for example a fourth PUCCH for the given WTRU, and so on. For example, if three PUCCH resources are reserved using offset to CCE method as described above, these three PUCCH resources may be used for channel selection multiplexing of HARQ feedback (ACK/NACKs) for three transport blocks of two serving cells or CCs. If four PUCCH resources are reserved, these four PUCCH resources may be used for channel selection multiplexing of HARQ feedback (ACK/NACKs) for four transport blocks. These four transport blocks may correspond to two serving cells or two component carriers. Also by way of example, the first two transport blocks may be the transport blocks of a primary cell and the other two transport blocks may be the transport blocks of a secondary cell. The offset may be of any value, e.g, one, and may be configurable by the eNodeB or network.

A second example solution may use the second CCE of PDCCH or DCI to assign or reserve an additional PUCCH resource for the WTRU. This solution may use the second CCE address of the PDCCH or DCI to indicate, assign or reserve an additional PUCCH resource, such as the third and fourth PUCCH resources for WTRU.

For example, the second CCE address of the first PDCCH or DCI may be used by the WTRU to indicate, assign or reserve the third PUCCH resource and the second CCE address of the second PDCCH may be used by the WTRU to indicate, assign or reserve the fourth PUCCH resource, and so on.

An eNodeB may schedule a PDCCH or DCI containing at least two CCEs. For example, a second CCE may be always scheduled or available to the WTRU when an additional PUCCH resource may be indicated or assigned to the WTRU.

The WTRU may fall back to using an offset of the first example solution when the second CCE in the PDCCH or DCI is not available, or a PDCCH or DCI with two or more CCEs may not be scheduled.

A method and device may be used for handling an over-sufficient PUCCH Resource for user channel multiplexing. The PUCCH resource that is not used may be re-assigned to other WTRU. By doing so, additional or more WTRUs may be multiplexed at the same time in the same PUCCH resource or RB and thus WTRU multiplexing gain may be increased and/or the overhead may be reduced.

In a first example solution, an offset may be applied to a PUCCH resource assignment for users. The offset may be used to align PUCCH resources for different users so that multiple users may share the same PUCCH resource pool. This approach may be used to increase WTRU multiplexing gain and/or to reduce overhead.

Different users may use different offset values to support user multiplexing. The offset may be configured per WTRU or per group of WTRUs on user-specific or user group-specific basis. Each WTRU or a group of WTRUs may be configured to use a subset of the PUCCH resource pool, once PUCCH resource for multiple users is aligned together in the same resource pool. The offset to the PUCCH resource and the subset of the PUCCH resource may be configurable by an eNodeB and may be WTRU-specific.

For example, PDCCH#1, 2, 3, 4 may be transmitted for WTRU1 and PDCCH#5, 6, 7, 8 may be transmitted for WTRU2. WTRU1 may be assigned by PUCCH resource #1, 2, 3, 4 (say Resource Set 1 or Resource Pool 1) and WTRU2 may be assigned by PUCCH resource #5, 6, 7, 8 (say Resource Set 2 or Resource Pool 2). To efficiently multiplex WTRUs, the PUCCH at WTRU1 may be re-routed using an offset to Resource Set 2 or Resource Pool 2, such as, for example PUCCH resource #5, 6, 7, 8 from Resource Set 1 or Resource Pool 1. A subset of Resource Set 2 or Resource Pool 2, for example PUCCH resource #5, 6 may be configured to WTRU1 and the other subset of Resource Set 2 or Resource Pool 2 may be configured to WTRU2, as an non-limiting example.

A second example solution may re-map the PUCCH resource from PDCCH CCE address. In this example, the PUCCH resource may be re-mapped from PDCCH CCE address to align PUCCH resource of users to be in the same set or pool for supporting user multiplexing. This method may modify a PDCCH-to-PUCCH mapping rule to support CS user multiplexing. Alternatively, an offset may be included in the PDCCH-to-PUCCH resource mapping function.

Users may use different resource subset (or partition) for user multiplexing. This is similar to solution 1. For example, PDCCH #1, 2, 3, 4 may be transmitted for WTRU1 and PDCCH #5, 6, 7, 8 may be transmitted for WTRU2. WTRU1 may be mapped to PUCCH resource #1, 2, 3, 4 and WTRU2 may be mapped to PUCCH resource #5, 6, 7, 8. By re-mapping the PUCCH resources for WTRUs, WTRU2 may be re-mapped to PUCCH resource #1, 2, 3, 4 from PUCCH resource #5, 6, 7, 8 while WTRU1 may still use the same PUCCH resource #1, 2, 3, 4. WTRU1 may be assigned by a PUCCH resource subset, for example PUCCH resource #1, 2 and WTRU2 may be assigned by another PUCCH resource subset, for example PUCCH resource #3, 4.

In a third example solution, a WTRU may use a redundant PUCCH resource for supporting UL MIMO. When redundant PUCCH resources are available, the redundant PUCCH resources may be re-assigned to other WTRUs for increasing user multiplexing gain, as described previously. Alternatively, such redundant PUCCH resources may be used to support uplink transmission extension or uplink MIMO extension. Redundant PUCCH resources may be used for supporting spatial orthogonal resource transmission at the WTRU when spatial orthogonal resource transmission is configured for the WTRU. The WTRU may use redundant PUCCH resources for supporting SORTD when SORTD is configured for the WTRU. The WTRU may use redundant PUCCH resources for supporting spatial orthogonal resource spatial multiplexing (SORSM) when SORSM is configured for the WTRU. The WTRU may use L−1 redundant PUCCH resources for SORTD (or SORSM, or the like) when SORTD (or SORSM, or the like) may be performed with L transmit antennas for a given WTRU. For example, when two transmit antenna SORTD is used, the WTRU may use one redundant PUCCH resource for supporting SORTD transmission and operation at the WTRU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

While the various embodiments have been described in connection with the various figures, it is to be understood that other similar embodiments may be used or modifications and additions may be made to the described embodiment for performing the same function of the various embodiments without deviating there from. Therefore, the embodiments should not be limited to any single embodiment, but rather should be construed in breadth and scope in accordance with the appended claims.

What is claimed is:

1. A method for selecting uplink (UL) transmission resources for transmitting uplink control information (UCI), the method comprising:
determining that an UCI should be transmitted;
selecting a physical channel resource for transmission of the UCI; and
transmitting, from a wireless transmit/receive unit (WRTU), the UCI over a physical uplink channel capable of supporting multiple component carriers using the selected physical channel resource.

2. The method of claim 1, wherein selecting the physical channel resource includes at least one of:
selecting a pre-determined UL component carrier (CC) for uplink transmission on a physical uplink control shared channel (PUSCH) upon a PUSCH resource being available in a subframe; or
selecting a pre-determined UL CC for uplink transmission on a physical uplink control channel (PUCCH) capable of UCI transmission in the subframe upon a PUSCH resource not being available in the subframe.

3. The method of claim 1, wherein the selected physical channel resource is an uplink primary component carrier (UL PCC).

4. The method of claim 1, wherein selecting the physical channel resource comprises selecting a UL component carrier (CC) randomly from a plurality of active uplink component carriers.

5. The method of claim 1, wherein selecting the physical channel resource further includes:
determining an uplink component carrier (UL CC) based, at least in part, on at least one of the following: a priority indication for the UL CC; an explicit signal from a network resource; a condition that the UL CC is currently used for transmission of UCI pertaining to an uplink/downlink CC pair; or a characteristic of a physical uplink shared control channel (PUSCH) resource being used for transmission.

6. The method of claim 5, wherein the characteristics of the PUSCH resource comprises at least one of: a number of resource blocks allocated for a PUSCH transmission; a modulation and coding scheme (MCS) allocated for the PUSCH transmission; a power headroom available for the PUSCH transmission; an available transmission power for the PUSCH transmission; or a pathloss associated with a downlink component carrier (DL CC) associated with the UL CC.

7. The method of claim 1, wherein selecting the physical channel resource includes:
determining a number of physical uplink shared channel (PUSCH) allocations for transmission in a subframe; and
selecting a UL component carrier (CC) based, at least in part, on the number of PUSCH allocations for transmission, wherein the selected UL CC is at least one of the following:
a UL CC with a physical uplink control channel (PUCCH) resource upon no PUSCH allocation existing for the subframe; a UL CC with a PUSCH allocation upon a PUSCH allocation existing for the subframe; or one or more UL CCs with associated PUSCH allocations upon one or more PUSCH allocations existing for the subframe.

8. A method for transmitting uplink control information (UCI) by a wireless transmit receive device (WTRU), comprising:
determining that UCI is to be transmitted;
identifying one or more coded symbols, the one or more coded symbols corresponding to the UCI; and
transmitting the UCI from the WTRU using the coded symbols simultaneously over a physical channel with multiple component carriers (CC).

9. The method of claim 8, further comprising determining a physical layer resource based, at least in part, on an offset parameter signaled from a first layer in communication with a second layer, the second layer including the physical channel.

10. The method of claim 9, wherein the offset parameter is scaled to increase a maximum offset value.

11. The method of claim 8, further comprising:
determining one or more first physical layer resources corresponding to a first transmission scheme, the first transmission scheme corresponding to a first set of offset parameters, and the first physical layer resources determined, based at least in part, on an at least one offset parameter of the first set of offset parameters identified by a first index value; and
determining one or more second physical layer resources corresponding to a second transmission scheme, the second transmission scheme corresponding to a second set of offset parameters, and the second physical layer resources determined, based at least in part, on at least one offset parameter of the second set of offset parameters, the at least one offset parameter of the second set of offset parameters identified by a differential value,
wherein the first index value, the first transmission scheme, and the second transmission scheme have respective logical positions and the differential value corresponds to a differential relative logical position between the first index value and a second index value.

12. The method of claim 8, further comprising:
identifying a first transmission power level per bit for a physical uplink shared channel (PUSCH) wherein the first transmission power level per bit is determined based on a condition in which the UCI is not included in a first transmission block;
transmitting a second transmission block that includes the UCI with a second transmission power level per bit for the PUSCH; and
adjusting the second transmission power level per bit to a level substantially similar to the first transmission power level per bit.

13. The method of claim 12, wherein the adjustment of the second transmission power level per bit is based, at least in part, on at least one of:
a type of UCI included in the second transmission block, wherein the type of UCI is at least one of an ACK/NACK, a PMI, a RI, or a CQI; a total number of UCI bits included in the second transmission block; a total number of data bits of the second transmission block in a single codeword transmission or a multiple codeword transmission; a total number of PUSCH symbols used for transmission of the UCI, wherein the UCI comprises at least one of an ACK/NACK, a CQI, a PMI, or, a RI; a total number of PUSCH symbols included in the second transmission block; a modulation order of at least one PUSCH symbol included in the second transmission block; a number of DL CCs for which the UCI is transmitted; or a value from a first layer in communication with a second layer, the second layer including the physical channel.

14. The method of claim 8, further comprising:
configuring at least one first offset parameter factor for a first codeword; and
configuring at least one second offset parameter factor for a second codeword, wherein the at least one second offset parameter compensates for a difference in at least one of a signal to interference-plus-noise ratio (SINR) or a modulation and coding scheme (MCS) between the first codeword and the second codeword.

15. The method of claim 8, further comprising multiplexing the UCI with uplink shared data (USD).

16. The method of claim 10, further comprising determining whether to use the original offset parameter or the scaled offset parameter based on at least on one of:
a number of configured downlink (DL) CCs at an identified subframe; one or more codewords receivable in a DL CC in the identified subframe; a number of activated DL CCs at the identified subframe; at least one of a value or an indication received upon activation of a DL CC; a number of decoded physical downlink shared channels (PDSCH) in the identified subframe; a signaled value corresponding to a number PDSCH assignment at the identified subframe; or a number of DL CCs available in discontinuous reception (DRX) active time.

17. A method for multiplexing wireless data, the method comprising:
multiplexing a plurality of wireless transmit/receive unit (WTRU) data in a same resource block (RB) using different subcarriers within the same RB; and
allocating one or more resource blocks (RBs) for uplink control information (UCI) for multiple wireless transmit/receive units (WTRUs).

18. The method of claim 17, wherein the number of different subcarriers, p, assigned to a multiplexed WTRU is
$$p = \frac{m \times 12}{q} ,$$
where q represents a total number of multiplexed WTRUs in at least one of a physical uplink shared channel (PUSCH) RB and physical uplink control channel (PUCCH) RB.

19. The method of claim 17, further comprising indexing a partitioned RB using a resource partition index.

20. The method of claim 17, wherein the multiplexing comprises at least one of frequency division multiplexing, code division multiplexing, or time division multiplexing.
